(19) United States
(12) Patent Application Publication
(10) Pub. No.: US 2025/0211025 A1
(43) Pub. Date: Jun. 26, 2025

(54) IN-BAND DEPLOYMENT FOR WIRELESS ENERGY AND INFORMATION TRANSFER

(71) Applicant: QUALCOMM Incorporated, San Diego, CA (US)

(72) Inventors: Xiaojie WANG, Hillsborough, NJ (US); Piyush GUPTA, Bridgewater, NJ (US); Luanxia YANG, Beijing (CN); Junyi LI, Greentown, PA (US)

(21) Appl. No.: 18/848,791

(22) PCT Filed: May 13, 2022
(86) PCT No.: PCT/CN2022/092646

§ 371 Date: Sep. 19, 2024

(51) Int. Cl. H02J 50/00; H02J 50/20

(52) U.S. Cl. CPC H02J 50/001; H02J 50/20

(57) ABSTRACT

Methods, systems, and devices for wireless communications are described. Some wireless communications systems may support energy harvesting devices, which may harvest power from received radio frequency (RF) signaling. To support energy harvesting, a network entity may configure one or more frequency resources within a channel bandwidth for wireless energy transfer (WET). The network entity may transmit a broadcast signal indicating the configuration to multiple devices. An energy harvesting device may receive the broadcast signal, identify the frequency resources configured for WET, and perform energy harvesting using signaling received in the frequency resources. For example, the network entity, a user equipment (UE), or any combination of these or other energy providing devices may transmit signaling in the frequency resources configured for WET to provide power to energy harvesting devices. In some examples, the network entity may further configure other frequency resources within the channel bandwidth for wireless information transfer (WIT).

### CROSS REFERENCE

The present Application is a 371 national phase filing of International PCT Application No. PCT/CN2022/092646 by WANG et al., entitled “IN-BAND DEPLOYMENT FOR WIRELESS ENERGY AND INFORMATION TRANSFER,” filed May 13, 2022, which is assigned to the assignee hereof, and which is expressly incorporated by reference in its entirety herein.

### FIELD OF TECHNOLOGY

The following relates to wireless communications, including in-band deployment for wireless energy and information transfer.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support energy harvesting devices. For example, an energy harvesting device may harvest power from radio frequency (RF) signaling received over-the-air to charge a battery at the energy harvesting device, power circuitry at the energy harvesting device, or both. However, in some cases, an energy harvesting device may fail to receive enough RF signaling (e.g., a threshold amount of power from RF signaling) to power the energy harvesting device. In such cases, the battery of the energy harvesting device may die, or the energy harvesting device may otherwise power down, potentially leading to missed communications, dropped connections, loss of stored information, or any combination thereof for the energy harvesting device.

### SUMMARY

The described techniques relate to improved methods, systems, devices, and apparatuses that support in-band deployment for wireless energy and information transfer. For example, the described techniques provide for improved resource allocation for wireless energy transfer (WET) within a channel bandwidth. Some wireless communications systems may support energy harvesting devices, which may harvest power from received radio frequency (RF) signaling. To support effective energy harvesting, a network entity may configure one or more frequency resources within a channel bandwidth for WET. The network entity may transmit a broadcast signal indicating the configuration to multiple devices (e.g., energy harvesting devices, user equipment (UEs)). An energy harvesting device may receive the broadcast signal, identify the frequency resources configured for WET, and perform energy harvesting using signaling received in the frequency resources. For example, the network entity, a UE, or any combination of these or other energy providing devices may transmit signaling in the frequency resources configured for WET to provide power to one or more energy harvesting devices. Such signaling received in the resources configured for WET may provide sufficient power (e.g., a threshold amount of power from RF signaling) to power the energy harvesting device. In some examples, the network entity may further configure other frequency resources within the channel bandwidth for wireless information transfer (WIT). The network entity may configure WET signaling to coexist with WIT signaling in the channel bandwidth, for example, by mitigating interference to WIT signaling by WET signaling, by managing bandwidth emissions for both WET and WIT signaling, or both.

A method for wireless communications is described. The method may include receiving, in a cellular network, a broadcast signal indicating one or more frequency resources within a channel bandwidth that are allocated for WET, receiving a signal within the one or more frequency resources, the signal being available for WET in accordance with the broadcast signal, and performing energy harvesting using the signal received within the one or more frequency resources allocated for WET.

An apparatus for wireless communications is described. The apparatus may include a processor, memory coupled with the processor, and instructions stored in the memory. The instructions may be executable by the processor to cause the apparatus to receive, in a cellular network, a broadcast signal indicating one or more frequency resources within a channel bandwidth that are allocated for WET, receive a signal within the one or more frequency resources, the signal being available for WET in accordance with the broadcast signal, and perform energy harvesting using the signal received within the one or more frequency resources allocated for WET.

Another apparatus for wireless communications is described. The apparatus may include means for receiving, in a cellular network, a broadcast signal indicating one or more frequency resources within a channel bandwidth that are allocated for WET, means for receiving a signal within the one or more frequency resources, the signal being available for WET in accordance with the broadcast signal, and means for performing energy harvesting using the signal received within the one or more frequency resources allocated for WET.

A non-transitory computer-readable medium storing code for wireless communications is described. The code may include instructions executable by a processor to receive, in a cellular network, a broadcast signal indicating one or more frequency resources within a channel bandwidth that are allocated for WET, receive a signal within the one or more frequency resources, the signal being available for WET in accordance with the broadcast signal, and perform energy harvesting using the signal received within the one or more frequency resources allocated for WET.

Some examples of the method, apparatuses, and non-transitory computer-readable medium described herein may further include operations, features, means, or instructions for performing additional energy harvesting using one or more additional signals received outside of the one or more frequency resources, the one or more additional signals being for WIT.

In some examples of the method, apparatuses, and non-transitory computer-readable medium described herein, receiving the broadcast signal may include operations, features, means, or instructions for receiving a master information block (MIB), a system information block (SIB), or both, where the MIB, the SIB, or a combination thereof indicates the one or more frequency resources.

In some examples of the method, apparatuses, and non-transitory computer-readable medium described herein, receiving the broadcast signal may include operations, features, means, or instructions for receiving a bitmap or an index of a bitmap that identifies the one or more frequency resources.

In some examples of the method, apparatuses, and non-transitory computer-readable medium described herein, the broadcast signal indicates respective sets of one or more frequency resources that are configured for WET within respective bandwidth parts (BWPs).

In some examples of the method, apparatuses, and non-transitory computer-readable medium described herein, the channel bandwidth corresponds to a licensed spectrum.

Another method for wireless communications is described. The method may include receiving, in a cellular network, a broadcast signal indicating one or more frequency resources within a channel bandwidth that are allocated for WET and transmitting a signal for WET in the one or more frequency resources in accordance with the broadcast signal.

An apparatus for wireless communications is described. The apparatus may include a processor, memory coupled with the processor, and instructions stored in the memory. The instructions may be executable by the processor to cause the apparatus to receive, in a cellular network, a broadcast signal indicating one or more frequency resources within a channel bandwidth that are allocated for WET and transmit a signal for WET in the one or more frequency resources in accordance with the broadcast signal.

Another apparatus for wireless communications is described. The apparatus may include means for receiving, in a cellular network, a broadcast signal indicating one or more frequency resources within a channel bandwidth that are allocated for WET and means for transmitting a signal for WET in the one or more frequency resources in accordance with the broadcast signal.

A non-transitory computer-readable medium storing code for wireless communications is described. The code may include instructions executable by a processor to receive, in a cellular network, a broadcast signal indicating one or more frequency resources within a channel bandwidth that are allocated for WET and transmit a signal for WET in the one or more frequency resources in accordance with the broadcast signal.

Some examples of the method, apparatuses, and non-transitory computer-readable medium described herein may further include operations, features, means, or instructions for power boosting the signal for WET based on a power boosting threshold.

Some examples of the method, apparatuses, and non-transitory computer-readable medium described herein may further include operations, features, means, or instructions for determining that a subset of the one or more frequency resources is allocated for WET to an energy harvesting device of a set of multiple energy harvesting devices, where the signal for WET may be transmitted to the energy harvesting device in the subset of the one or more frequency resources.

Some examples of the method, apparatuses, and non-transitory computer-readable medium described herein may further include operations, features, means, or instructions for receiving control signaling indicating a subcarrier spacing (SCS) to use for the signal for WET, the control signaling including a MIB, a SIB, radio resource control (RRC) signaling, a medium access control element (MAC-CE), downlink control information (DCI), or a combination thereof, where the signal for WET may be transmitted further based on the SCS.

In some examples of the method, apparatuses, and non-transitory computer-readable medium described herein, the channel bandwidth includes a first BWP preceding the one or more frequency resources in a frequency domain and a second BWP following the one or more frequency resources in the frequency domain, the first BWP and the second BWP corresponding to a same SCS. In some such examples of the method, apparatuses, and non-transitory computer-readable medium described herein, the signal for WET includes an orthogonal frequency-division multiplexing (OFDM) waveform with the same SCS as the first BWP and the second BWP.

In some examples of the method, apparatuses, and non-transitory computer-readable medium described herein, the channel bandwidth includes a first BWP preceding the one or more frequency resources in a frequency domain and a second BWP following the one or more frequency resources in the frequency domain, the first BWP corresponding to a first SCS and the second BWP corresponding to a second SCS. In some such examples of the method, apparatuses, and non-transitory computer-readable medium described herein, the signal for WET includes an OFDM waveform with the first SCS, and the signal for WET may be separated from the second BWP in the frequency domain by a guard band, or the signal for WET includes the OFDM waveform with the second SCS, and the signal for WET may be separated from the first BWP in the frequency domain by the guard band.

In some examples of the method, apparatuses, and non-transitory computer-readable medium described herein, the channel bandwidth includes a first BWP preceding the one or more frequency resources in a frequency domain and a second BWP following the one or more frequency resources in the frequency domain, the first BWP corresponding to a first SCS and the second BWP corresponding to a second SCS. In some such examples of the method, apparatuses, and non-transitory computer-readable medium described herein, the signal for WET includes an OFDM waveform with a third SCS different from the first SCS and the second SCS, where the signal for WET may be separated from the first BWP in the frequency domain by a first guard band and may be separated from the second BWP in the frequency domain by a second guard band.

In some examples of the method, apparatuses, and non-transitory computer-readable medium described herein, the channel bandwidth includes a first BWP preceding the one or more frequency resources in a frequency domain and a second BWP following the one or more frequency resources in the frequency domain, the first BWP corresponding to a first SCS and the second BWP corresponding to a second SCS. In some such examples of the method, apparatuses, and non-transitory computer-readable medium described herein, the signal for WET includes an OFDM waveform with a set of multiple SCSs including at least the first SCS in a first portion adjacent to the first BWP in the frequency domain and the second SCS in a second portion adjacent to the second BWP in the frequency domain.

In some examples of the method, apparatuses, and non-transitory computer-readable medium described herein, the signal for WET may be dedicated for energy transfer or includes physical uplink control channel (PUCCH) signaling, physical uplink shared channel (PUSCH) signaling, sidelink signaling, signal shaping signaling, or a combination thereof.

A method for wireless communications is described. The method may include allocating, in a cellular network, one or more frequency resources within a channel bandwidth for WET and transmitting a broadcast signal indicating the one or more frequency resources that are configured for WET.

An apparatus for wireless communications is described. The apparatus may include a processor, memory coupled with the processor, and instructions stored in the memory. The instructions may be executable by the processor to cause the apparatus to allocate, in a cellular network, one or more frequency resources within a channel bandwidth for WET and transmit a broadcast signal indicating the one or more frequency resources that are configured for WET.

Another apparatus for wireless communications is described. The apparatus may include means for allocating, in a cellular network, one or more frequency resources within a channel bandwidth for WET and means for transmitting a broadcast signal indicating the one or more frequency resources that are configured for WET.

A non-transitory computer-readable medium storing code for wireless communications is described. The code may include instructions executable by a processor to allocate, in a cellular network, one or more frequency resources within a channel bandwidth for WET and transmit a broadcast signal indicating the one or more frequency resources that are configured for WET.

Some examples of the method, apparatuses, and non-transitory computer-readable medium described herein may further include operations, features, means, or instructions for allocating one or more additional frequency resources within the channel bandwidth for WIT on an uplink channel, a downlink channel, or both.

In some examples of the method, apparatuses, and non-transitory computer-readable medium described herein, the broadcast signal further indicates the one or more additional frequency resources that are allocated for WIT, the broadcast signal including a MIB, a SIB, or both.

Some examples of the method, apparatuses, and non-transitory computer-readable medium described herein may further include operations, features, means, or instructions for transmitting, to an energy harvesting device, a signal for WET in the one or more frequency resources based on the allocated one or more frequency resources.

Some examples of the method, apparatuses, and non-transitory computer-readable medium described herein may further include operations, features, means, or instructions for power boosting the signal for WET based on a power boosting threshold.

Some examples of the method, apparatuses, and non-transitory computer-readable medium described herein may further include operations, features, means, or instructions for selecting a first set of contiguous frequency resources of the one or more frequency resources for power boosting the signal for WET, where the signal for WET may be power boosted in the first set of contiguous frequency resources based on the selecting and refraining from power boosting the signal for WET in a second set of contiguous frequency resources of the one or more frequency resources.

In some examples of the method, apparatuses, and non-transitory computer-readable medium described herein, the signal for WET may be dedicated for energy transfer or includes physical downlink control channel (PDCCH) signaling, physical downlink shared channel (PDSCH) signaling, reference signaling, signal shaping signaling, or a combination thereof.

In some examples of the method, apparatuses, and non-transitory computer-readable medium described herein, allocating the one or more frequency resources for WET may include operations, features, means, or instructions for allocating a first subset of the one or more frequency resources for WET to a first energy harvesting device of a set of multiple energy harvesting devices and allocating a second subset of the one or more frequency resources for WET to a second energy harvesting device of the set of multiple energy harvesting devices.

In some examples of the method, apparatuses, and non-transitory computer-readable medium described herein, the broadcast signal includes a MIB, a SIB, or both.

Some examples of the method, apparatuses, and non-transitory computer-readable medium described herein may further include operations, features, means, or instructions for configuring the channel bandwidth with a first BWP corresponding to an SCS and preceding the one or more frequency resources in a frequency domain and configuring the channel bandwidth with a second BWP corresponding to the SCS and following the one or more frequency resources in the frequency domain.

Some examples of the method, apparatuses, and non-transitory computer-readable medium described herein may further include operations, features, means, or instructions for applying, to first signaling transmitted in the one or more frequency resources that may be configured for WET, an emission threshold associated with the first signaling affecting frequency resources outside the one or more frequency resources and refraining from applying, to second signaling transmitted in the frequency resources outside the one or more frequency resources that may be configured for WET, the emission threshold associated with the second signaling affecting the one or more frequency resources.

Some examples of the method, apparatuses, and non-transitory computer-readable medium described herein may further include operations, features, means, or instructions for applying a total emission threshold associated with both first signaling for WET and second signaling for WIT affecting frequency resources outside the channel bandwidth.

### BRIEF DESCRIPTION OF THE DRAWINGS

FIGS. 1 and 2 illustrate examples of wireless communications systems that support in-band deployment for wireless energy and information transfer in accordance with one or more aspects of the present disclosure.

FIG. 3 illustrates an example of an in-band resource allocation that supports in-band deployment for wireless energy and information transfer in accordance with one or more aspects of the present disclosure.

FIG. 4 illustrates an example of a process flow that supports in-band deployment for wireless energy and information transfer in accordance with one or more aspects of the present disclosure.

FIGS. 5 and 6 show block diagrams of devices that support in-band deployment for wireless energy and information transfer in accordance with one or more aspects of the present disclosure.

FIG. 7 shows a block diagram of a communications manager that supports in-band deployment for wireless energy and information transfer in accordance with one or more aspects of the present disclosure.

FIG. 8 shows a diagram of a system including a device that supports in-band deployment for wireless energy and information transfer in accordance with one or more aspects of the present disclosure.

FIGS. 9 and 10 show block diagrams of devices that support in-band deployment for wireless energy and information transfer in accordance with one or more aspects of the present disclosure.

FIG. 11 shows a block diagram of a communications manager that supports in-band deployment for wireless energy and information transfer in accordance with one or more aspects of the present disclosure.

FIG. 12 shows a diagram of a system including a device that supports in-band deployment for wireless energy and information transfer in accordance with one or more aspects of the present disclosure.

FIGS. 13 through 15 show flowcharts illustrating methods that support in-band deployment for wireless energy and information transfer in accordance with one or more aspects of the present disclosure.

### DETAILED DESCRIPTION

Some wireless communications systems may include energy harvesting devices. An energy harvesting device may harvest power from radio frequency (RF) signaling received over-the-air to charge a battery at the energy harvesting device, power circuitry at the energy harvesting device, or both. In some systems, energy harvesting devices may harvest energy from ambient RF signals. For example, an energy harvesting device may monitor for signals (e.g., on a channel, on a carrier) and may perform energy harvesting operations on detected signals received by the energy harvesting device. However, such signals may not be intended for energy harvesting. For example, the ambient RF signals may include information signals or other RF signals sent between devices. Because such signals are not intended for energy harvesting, the signals may not be optimized or otherwise configured to support efficient energy harvesting procedures. As such, relying on ambient RF signals to power an energy harvesting device may be insufficient (e.g., may fail to meet a threshold power level in order to power the energy harvesting device). For example, the energy harvesting device may fail to receive enough power from ambient RF signals to charge a battery, power circuitry, or perform one or more other operations.

To support power harvesting techniques, a wireless communications system may configure in-band resources for wireless energy transfer (WET). For example, a network entity may configure one or more frequency resources within a channel bandwidth for WET signaling. The network entity may transmit a broadcast signal (e.g., a master information block (MIB), a system information block (SIB)) indicating the configuration to multiple devices. An energy harvesting device may receive the broadcast signal and identify the frequency resources configured for WET signaling. In some examples, an energy providing device (e.g., a user equipment (UE) or an energy transmitter) may also receive the broadcast signal and identify the frequency resources configured for WET signaling. The network entity or any other energy providing device (e.g., a UE, an energy transmitter) may transmit signaling in the frequency resources configured for WET to provide power to one or more energy harvesting devices. The energy harvesting device may perform energy harvesting using the signaling received in the frequency resources (e.g., signaling configured for WET). Such signaling configured for WET may provide sufficient power—such as a threshold amount of power from RF signaling—to power the energy harvesting device. For example, by harvesting energy from the resources and signaling configured for WET, the energy harvesting device may charge a battery, power circuitry, or perform one or more other operations at the energy harvesting device.

In some examples, the network entity may additionally configure in-band resources for wireless information transfer (WIT). For example, wireless devices may communicate information in the resources configured for WIT. In some cases, an energy harvesting device may perform additional energy harvesting using WIT signaling (e.g., received in resources configured for WIT). The network entity may configure the WET signaling to coexist with the WIT signaling within the channel bandwidth. For example, the network entity may configure a subcarrier spacing (SCS) for the WET signaling waveform to mitigate interference with WIT signaling in the channel. Additionally, or alternatively, the network entity may configure one or more guard bands between resources configured for WET and resources configured for WIT to mitigate interference from the WET signaling on the WIT signaling. In some cases, the network entity may manage emissions within the channel bandwidth and outside of the channel bandwidth by accounting for emissions from both WET and WIT signaling.

Aspects of the disclosure are initially described in the context of wireless communications systems. Additional aspects of the disclosure are described with respect to an in-band resource allocation and a process flow. Aspects of the disclosure are further illustrated by and described with reference to apparatus diagrams, system diagrams, and flowcharts that relate to in-band deployment for wireless energy and information transfer.

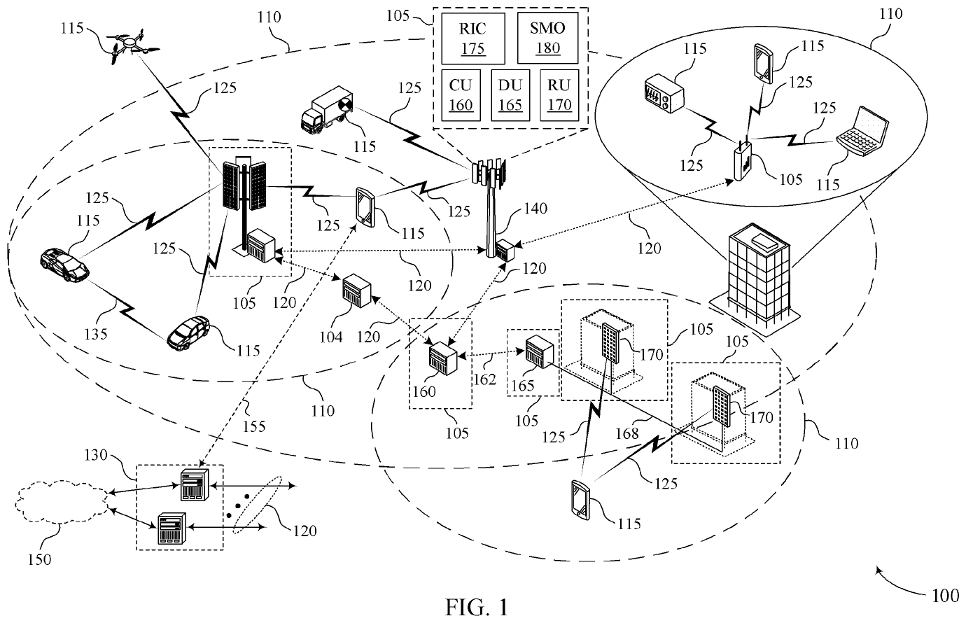

FIG. 1 illustrates an example of a wireless communications system 100 that supports in-band deployment for wireless energy and information transfer in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support in-band deployment for wireless energy and information transfer as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The wireless communications system 100 may include devices (e.g., UEs 115, network entities 105) that support energy harvesting techniques. For example, a UE 115—which may be an example of an energy harvesting device—may charge a battery or otherwise power circuitry at the UE 115 using energy from RF signaling, solar energy, vibrational energy, or any combination thereof. Examples of energy harvesting devices may include radio frequency identification (RFID) tags, passive IoT devices, and UEs 115 (e.g., relatively low power or low complexity UEs 115), among other energy harvesting devices. An energy harvesting device, as described herein, may receive a signal and may harvest energy (e.g., power one or more operations at the energy harvesting device) using the RF energy of the signal.

For example, the wireless communications system 100 may support RFID technologies. Some example systems using RFID technologies (e.g., RFID systems) may include inventory management, asset management, or both for a warehouse (e.g., inside the warehouse, outside the warehouse), IoT systems, sustainable sensor networks (e.g., in factories, in agricultural systems), smart homes, or any combination of these or other systems including RFID devices. RFID systems may include relatively small transponders (e.g., microchips), which may be referred to as RFID tags, that emit an information-bearing signal in response to a received signal. An RFID tag may operate without a battery at relatively low operating expenses (OPEX), relatively low maintenance costs, and long-life cycles based on using energy harvesting techniques. Alternatively, an RFID tag may operate with a battery as a semi-passive or active RFID device (e.g., at a relatively higher cost) and may use energy harvesting techniques to support charging the battery. For example, the RFID tag (e.g., a passive, semi-passive, or active RFID device) may harvest energy over-the-air to power circuitry (e.g., transmission/reception circuitry) at the RFID tag. The RFID tag may receive a first signal over-the-air, harvest energy from the signal, and transmit—in response to the received signal—a second signal, which may be an example of a backscatter modulated information signal. In some examples, the first signal may be transmitted by an RFID reader, the second signal may be received at the RFID reader, or both.

Additionally, or alternatively, the wireless communications system 100 may support passive IoT technologies. For example, URLLC systems, MTC systems, or other systems (e.g., 5G systems, 6G systems, and beyond) may support passive IoT technologies. In some examples, the wireless communications system 100 may support MTC devices, NB-IoT devices, reduced capability (RedCap) devices, or some combination thereof for MTC operations, where such devices may operate using energy harvesting techniques. Additionally, or alternatively, the wireless communications system 100 may support RFID-type sensors (e.g., passive IoT devices) for asset management, logistics, warehousing, manufacturing, or any other use cases. The prevalence of such passive IoT devices in some wireless communications systems 100 may affect the energy usage within the wireless communications systems 100. For example, to support passive IoT devices throughout a system, the passive IoT devices may harvest energy from signaling (e.g., ambient RF signaling, dedicated RF signaling) to efficiently maintain power at the passive IoT devices.

In some cases, the network (e.g., via a network entity 105, such as a base station 140 or an RU 170) may manage passive IoT devices (e.g., one or more UEs 115). For example, a network entity 105 may read information from a passive IoT device, write information to the passive IoT device, or both. The network entity 105 may also provide energy to the passive IoT device (e.g., using over-the-air RF signaling). Additionally, or alternatively, some UEs 115 (e.g., energy providing devices) may provide energy to other UEs 115 (e.g., energy harvesting devices, such as passive IoT devices). In some examples, a passive IoT device may reflect an information-bearing signal to a network entity 105 (e.g., as part of, as a result of, or in addition to an energy harvesting operation at the passive IoT device). The network entity 105 may receive the reflected signal from the passive IoT device and decode the information in the reflected signal (e.g., transmitted by the passive IoT device).

An energy harvesting device (e.g., an RFID tag, a passive IoT device, a UE 115) may include power harvesting circuitry. The power harvesting may be non-linear with respect to the input power at the power harvesting circuitry, for example, due to diodes in the circuitry. For example, the energy harvesting device may receive a signal at an antenna and may send the signal for impedance matching. Following impedance matching, the signal may be sent to the power harvesting circuitry (e.g., for energy harvesting), a demodulator (e.g., for demodulation if the signal includes information for the energy harvesting device), or both. In some cases, the power harvesting circuitry may include a threshold input power (e.g., for the received signal) at which the circuitry turns on and performs power harvesting operations on the signal. The threshold input power may be based on a turn-on voltage for one or more diodes in the power harvesting circuitry. For example, the threshold input power may be −20 decibel-milliwatts (dBm), −10 dBm, or some other value for triggering the power harvesting circuitry to activate. If the input power of the received signal (e.g., at reception, following impedance matching) satisfies the threshold input power (e.g., is greater than or equal to the threshold input power), the received signal may be processed by the power harvesting circuitry in order to harvest energy from the signal. In some cases, the power harvesting circuitry may be relatively more efficient at lower frequencies due to diode junction capacitance and resistance (e.g., based on frequency-selective conversion efficiency). The power harvesting circuitry may send the resulting harvested energy to a regulator, a booster converter, or both. The regulator may provide energy (e.g., based on the energy received from the power harvesting circuitry) to one or more microcontroller units (MCU), one or more sensors, or both to power such components. The booster converter may send energy (e.g., based on the energy received from the power harvesting circuitry) to an energy reservoir or other energy storage mechanism (e.g., a battery) for later use.

In some systems, energy harvesting devices may harvest energy from ambient RF signals. For example, an energy harvesting device may monitor for signals (e.g., on a channel, on a carrier) and may perform energy harvesting operations on detected signals received by the energy harvesting device. Such signals may not be intended for energy harvesting; that is, the energy harvesting device may perform energy harvesting on information signals or other RF signals sent between different devices, sent to the energy harvesting device, or both. Because such signals (e.g., digital television (DTV) signals, global system for mobile communication (GSM) signals, 3G signals, Wi-Fi signals, or other ambient RF signals) are not dedicated for energy harvesting, the signals may not be optimized or otherwise configured to support efficient energy harvesting. For example, the power density of ambient RF signals may be lower than a threshold density (e.g., 10 nanoWatt per square centimeter (nW/cm2)) that supports effective charging for energy harvesting devices. Additionally, or alternatively, the power level of ambient RF signals may vary over time, by location, or both. As such, relying on ambient RF signals to power an energy harvesting device may be insufficient. For example, the energy harvesting device may fail to receive enough power from ambient RF signals to charge a battery, power circuitry, perform one or more operations, or any combination thereof.

To support energy harvesting devices (e.g., RFID tags, passive IoT devices, UEs 115), the wireless communications system 100 may use dedicated energy sources, dedicated energy harvesting signals, or both. For example, a first signal type may be dedicated for WIT. Such signaling may carry information between devices in the wireless communications system 100 (e.g., between UEs 115, network entities 105, or some combination thereof). In some cases, signaling dedicated for WIT (e.g., NR signaling) may additionally be used for energy harvesting (e.g., ambient energy harvesting). A second signal type may be dedicated for WET. Such signaling may refrain from carrying information between devices in the wireless communications system 100 and instead may include RF energy to be used for energy harvesting. As such, the second signal type may be configured to optimize—or otherwise improve—the efficiency of harvesting energy from the second signal type.

Frequency bands may be reserved for WET, WIT, or a combination of WET and WIT. For example, the network (e.g., via a network entity 105) may configure a frequency band for WET signaling, WIT signaling, or both. In some cases, the network may configure a frequency band dedicated for WET. Such a dedicated frequency band may provide energy coverage for multiple energy harvesting devices (e.g., pervasive, perpetual wireless-powered IoT devices) in the wireless communications system 100. By using dedicated WET signaling, the wireless communications system 100 may improve the effective power density for energy harvesting, allowing energy harvesting devices to receive enough power (e.g., from RF signaling) to charge a battery, power circuitry, perform one or more operations, or any combination thereof. Specifically, in-band deployment of WET (e.g., with WIT) may support improved energy harvesting for energy harvesting devices, reducing the likelihood of an energy harvesting device losing power, improving communications with energy harvesting devices, and improving the reliability of energy harvesting devices.

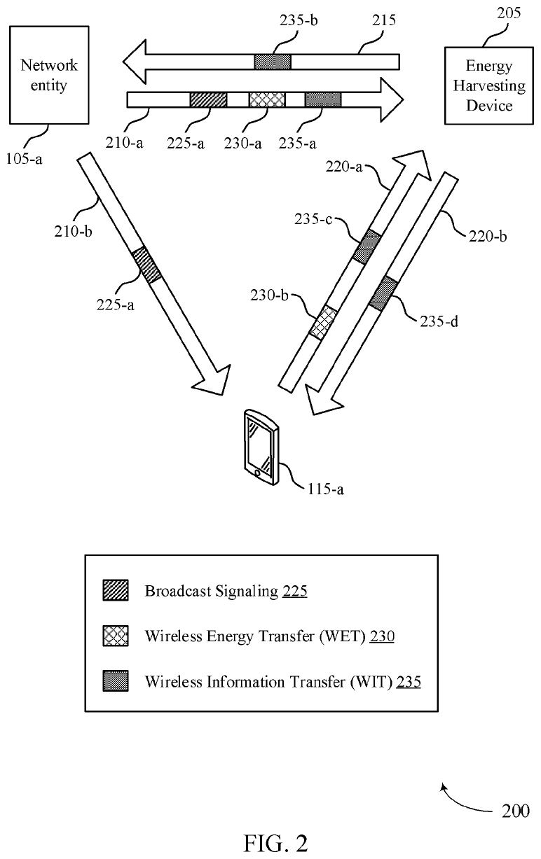

FIG. 2 illustrates an example of a wireless communications system 200 that supports in-band deployment for wireless energy and information transfer in accordance with one or more aspects of the present disclosure. The wireless communications system 200 may support aspects of the wireless communications system 100. For example, the wireless communications system 200 may include a network entity 105-a, a UE 115-a, and an energy harvesting device 205, which may be examples of corresponding devices described with respect to FIG. 1. The energy harvesting device 205 may be an example of a UE 115, a network entity 105, or any other device that uses energy harvesting techniques (e.g., an RFID tag, a passive IoT device). The network entity 105-a, the UE 115-a, or both may use dedicated WET signaling 230 to provide energy to the energy harvesting device 205. Additionally, the network entity 105-a, the UE 115-a, the energy harvesting device 205, or any combination thereof may communicate information using WIT signaling 235. The wireless communications system 200 may support in-band deployment of both WET signaling 230 and WIT signaling 235 to support efficient resource usage of a channel bandwidth.

A network entity 105-a may reserve one or more frequency resources (e.g., RBs) for WET signaling 230 within a channel bandwidth. In some examples, the reserved frequency resources may be cell-specific. For example, the network entity 105-a may configure, for a specific cell, frequency resources (e.g., in one or more BWPs) for WET signaling 230. In some cases, the network entity 105-a may transmit broadcast signaling 225 indicating the configuration of the frequency resources for WET signaling 230. For example, the network entity 105-a may broadcast the configuration (e.g., in a MIB, in a SIB) to multiple devices, such as an energy harvesting device 205 via a downlink channel 210-a and a UE 115-a via a downlink channel 210-b. Additionally, or alternatively, the network entity 105-a may configure frequency resources for WIT signaling 235. The network entity 105-a may broadcast an indication (e.g., a configuration) of the WIT resources in a MIB, a SIB, or both to the energy harvesting device 205, the UE 115-a, or both. For example, the network entity 105-a may broadcast a configuration of WET resources and WIT resources for a channel bandwidth to multiple devices in the wireless communications system 200.

Devices camping on the cell (e.g., the energy harvesting device 205 and the UE 115-a connected to the network via the network entity 105-a serving the cell) may identify, based on the broadcast signaling 225, the frequency resources configured for WET signaling 230. The energy harvesting device 205 may tune power harvesting circuitry to the frequency resources in the band, may activate the power harvesting circuitry for the WET signaling 230, or both to support efficient power harvesting for the specific frequency resources. Accordingly, the energy harvesting device 205 may harvest energy from the licensed spectrum (e.g., a portion of the licensed frequency spectrum configured for WET and WIT). The licensed spectrum may support relatively more controllable interference than other frequency spectrums (e.g., the UHF spectrum). Additionally, or alternatively, the licensed spectrum may support relatively higher transmit powers for WET signaling 230 than other frequency spectrums (e.g., the UHF spectrum). To support efficient deployment, a software update at the network entity 105-a may allow the network entity 105-a to configure in-band resources for WET signaling 230.

The energy harvesting device 205 may receive broadcast signaling 225-a and may determine one or more frequency resources to monitor for energy harvesting. In some examples, the energy harvesting device 205 may harvest energy from WET signaling 230 transmitted in frequency resources dedicated for WET (e.g., based on the configuration by the network). In some cases, the network entity 105-a may transmit WET signaling 230-a on the downlink channel 210-a in one or more frequency resources dedicated for WET. That is, the network entity 105-a may transmit the configuration to the energy harvesting device 205 and may also transmit WET signaling 230-a to the energy harvesting device 205 in the resources dedicated for WET signaling 230 in the configuration.

Additionally, or alternatively, the UE 115-a may transmit WET signaling 230-b on a sidelink channel 220-a in one or more frequency resources dedicated for WET. For example, the UE 115-a may receive the configuration (e.g., in the broadcast signaling 225-a) from the network entity 105-a and may determine whether to transmit WET signaling 230 in frequency resources allocated for WET signaling 230. In some examples, the UE 115-a may determine whether to transmit WET signaling 230 based on a communication schedule of the UE 115-a (e.g., if the UE 115-a is not scheduled for other transmissions or reception in the frequency resources), an available power at the UE 115-a (e.g., if the available power at the UE 115-a satisfies a power threshold), or one or more other parameters or decision metrics.

Additionally, or alternatively, an energy transmitter may transmit WET signaling 230 in frequency resources allocated for WET signaling 230. An energy transmitter may be an example of a device configured to perform WET for energy harvesting purposes. The energy transmitter may be deployed in the wireless communications system 200 to support WET. The energy transmitter may identify the frequency resources allocated for WET signaling 230 (e.g., based on the configuration from broadcast signaling or based on a configuration of the energy transmitter) and may access the allocated frequency resources to supply power towards one or more energy harvesting devices 205.

The energy harvesting device 205 may receive the WET signaling 230 (e.g., from the network entity 105-a, the UE 115-a, the energy transmitter, or some combination of these devices or other devices configured for WET) and may harvest power from the WET signaling 230 using power harvesting circuitry at the energy harvesting device 205. Additionally, or alternatively, the energy harvesting device 205 may harvest energy from other transmissions (e.g., RF signaling) in the wireless communications system 200. For example, the energy harvesting device 205 may harvest energy from WIT signaling 235 (e.g., RF signals used to communicate information between wireless devices). In some examples, the energy harvesting device 205 may harvest energy from WIT signaling 235 without using the WIT signaling 235 for information communication. For example, the energy harvesting device 205 may refrain from demodulating the WIT signaling 235, refrain from decoding the WIT signaling 235, or both. For example, the UE 115-a and the network entity 105-a may communicate information to one another using WIT signaling 235. The energy harvesting device 205 may detect the WIT signaling 235 (e.g., between the UE 115-a and the network entity 105-a) and may harvest energy from the WIT signaling 235.

In some other examples, the energy harvesting device 205 may receive WIT signaling 235 and decode the WIT signaling 235 for information in addition to harvesting energy from the WIT signaling 235. The WIT signaling 235 may be transmitted in resources (e.g., frequency resources) configured for WIT signaling 235 by the network. For example, a channel bandwidth may be configured to include a first subset of frequency resources configured for WET signaling 230, a second subset of frequency resources configured for WIT signaling 235, and—in some cases—a third subset of frequency resources configured to support WET signaling 230, WIT signaling 235, or a combination of the two. The network entity 105-a may transmit WIT signaling 235-a to the energy harvesting device 205 on the downlink channel 210-a. Additionally, or alternatively, the UE 115-a may transmit WIT signaling 235-c to the energy harvesting device 205 on the sidelink channel 220-a. The energy harvesting device 205 may determine information from the WIT signaling 235, harvest energy from the WIT signaling 235, or both.

Additionally, or alternatively, the energy harvesting device 205 may use the resources configured for WIT signaling 235 for transmissions. For example, the energy harvesting device 205 may transmit WIT signaling 235-b to the network entity 105-a on an uplink channel 215. In some cases, the energy harvesting device 205 may transmit WIT signaling 235-d to the UE 115-a on a sidelink channel 220-b. In some cases, the energy harvesting device 205 may transmit WIT signaling 235 to request WET signaling 230 (e.g., from a specific device, such as the network entity 105-a or the UE 115-a, or from any device that receives the WIT signaling 235 and is capable of providing energy). In some other cases, the energy harvesting device 205 may transmit other information (e.g., confirmation signaling, backscatter modulated information signaling, sensor data). Accordingly, the wireless devices in the wireless communications system 200 may communicate information and transmit signaling dedicated for energy harvesting within a same band (e.g., same frequency band, same BWP, same channel bandwidth, same carrier bandwidth).

In some examples, WET signaling 230 and WIT signaling 235 may occupy the same resource. For example, one or more devices may transmit information signals and energy signals using the same resource. In some other examples, WET signaling 230 and WIT signaling 235 may occupy different resources. For example, the network entity 105-a may configure one or more WIT BWPs and one or more WET bands (e.g., WET BWPs). Resources configured for WIT may be reserved for downlink transmissions, uplink transmissions, or both (e.g., in the time domain, in the frequency domain, in the spatial domain). In some cases, WIT resources may occupy different subcarriers, different subchannels, or both in different RBs. For example, the network entity 105-a may select downlink subcarriers for WIT signaling 235 such that the downlink subcarriers are separated in frequency by a value, Δf_{DL}. The value, Δf_{DL}, may be selected such that multi-path destructive interference may be resolved when a device hops between subcarriers. For example, if a first downlink subcarrier configured for WIT signaling 235 is at a frequency f₁, destructive multi-path interference may occur if the first path and the second path differ by 0.5×c/f₁. Accordingly, the network may select a second downlink subcarrier to configure for WIT signaling 235 at a frequency f₂ such that f₂=f₁+Δf_{DL}, where 0.5×f₂/f₁≠0.5. The network may select uplink subcarriers for WIT signaling 235 based on one or more downlink subcarriers for WIT signaling 235 to support backscattering with subcarrier modulation. For example, the network may apply a relatively small frequency shift to a downlink subcarrier for WIT signaling 235 to determine an uplink subcarrier for WIT signaling 235. In some cases, to reduce hardware complexity, the network may select an uplink subcarrier for WIT signaling 235 such that the additional frequency separate to a downlink subcarrier for WIT signaling 235 satisfies Δfₛₑₚₐᵣₐₜᵢₒₙ=f₁/N, where N may be select integers or powers of two (e.g., 8, 16, 32, 64, 128).

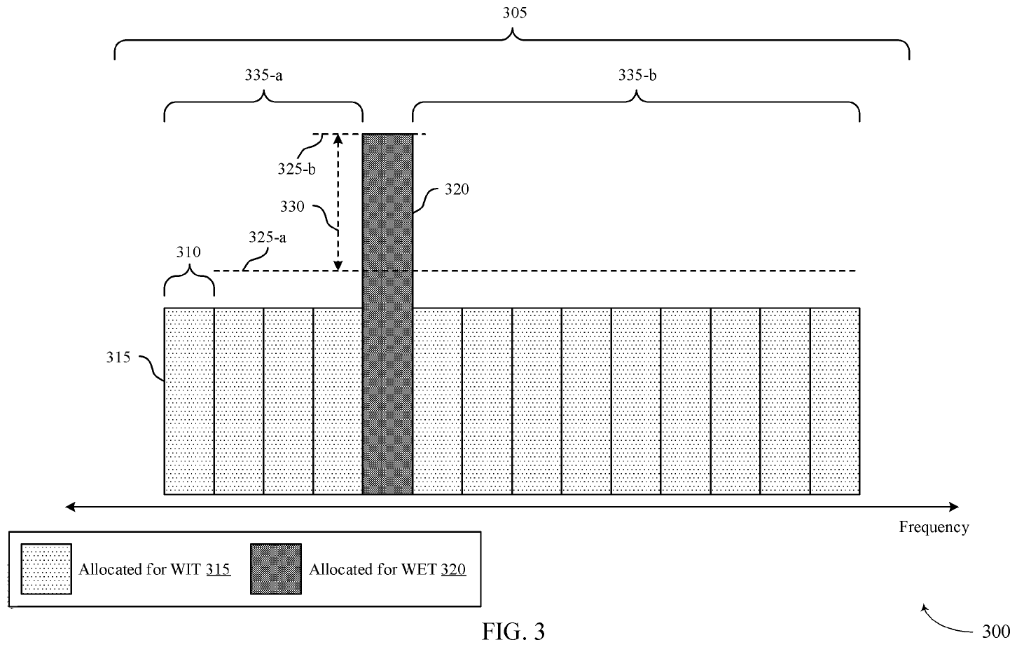

FIG. 3 illustrates an example of an in-band resource allocation 300 that supports in-band deployment for wireless energy and information transfer in accordance with one or more aspects of the present disclosure. The in-band resource allocation 300 may be used in a wireless communications system 100, a wireless communications system 200, or both. For example, a network entity 105, such as a network entity 105 described with reference to FIGS. 1 and 2 (e.g., a base station 140 or other network device), may configure the in-band resource allocation 300 to support WET and WIT. A UE 115, such as a UE 115 described with reference to FIGS. 1 and 2, may identify the in-band resource allocation 300 (e.g., by receiving an indication of the configuration from a network entity 105) and determine resources allocated for WIT 315, resources allocated for WET 320, or both. In some cases, the UE 115 may be an example of an energy providing device and may identify the resources allocated for WET 320 in order to transmit WET signaling in the resources allocated for WET 320. In some other cases, the UE 115 may be an example of an energy harvesting device and may identify the resources allocated for WET 320 in order to receive WET signaling in the resources allocated for WET 320 to perform energy harvesting.

The in-band resource allocation 300 may support in-band deployment of WET (e.g., resources allocated for WET 320). The in-band resource allocation 300 may configure frequency resources dedicated for WIT signaling, frequency resources dedicated for WET signaling, or a combination thereof. The network (e.g., a network entity 105) may determine (e.g., configure) the in-band resource allocation 300 for a channel bandwidth (e.g., a specific frequency band, a specific BWP). In some cases, the in-band resource allocation 300 may correspond to a specific cell.

As illustrated, resources allocated for WET 320 and resources allocated for WIT 315 may be frequency-division duplexed (FDDed) within a channel bandwidth 305 (e.g., an NR channel bandwidth or other channel bandwidth). The channel bandwidth 305 may be organized according to frequency resources, such as RBs 310, subcarriers, or other units of frequency. A frequency resource of the channel bandwidth 305 may be configured for WET signaling, WIT signaling, both (e.g., concurrently or at different times according to a time-division duplexing (TDD) framework), or neither (e.g., a gap in the frequency domain). For example, the network (e.g., via a network entity 105) may configure one or more resources allocated for WET 320 and one or more resources allocated for WIT 315 within the channel bandwidth 305 (e.g., in-band).

In some cases, WET subcarriers or subchannels, WIT subcarriers or subchannels, or both may be smaller than one RB 310. Additionally, or alternatively, the network (e.g., via a network entity 105) may configure WIT resources to avoid synchronization signal block (SSB) resources, physical random access channel (PRACH) resources, or both. In some examples, UEs 115 may avoid or puncture transmissions on WIT subcarriers or subchannels.

An energy harvesting device (e.g., a UE 115 or other device) operating on the channel bandwidth 305, operating on the cell specific to the in-band resource allocation 300, or both may harvest energy from the resources allocated for WET 320. For example, the energy harvesting device may monitor the resources allocated for WET 320 for WET signaling and may send signaling received on the resources allocated for WET 320 to power harvesting circuity for energy harvesting. Additionally, or alternatively, the energy harvesting device may harvest energy from the resources allocated for WIT 315. For example, the energy harvesting device may harvest energy from RBs 310 adjacent to the RBs 310 configured for WET signaling (e.g., based on an SSB) or may harvest energy from any other RBs 310 in the channel bandwidth 305. However, signaling received on resources allocated for WIT 315 may not be as optimized for energy harvesting as signaling received on resources allocated for WET 320. Specifically, WET signals may be configured or otherwise designed to improve energy harvesting at an energy harvesting device.

For example, WET signaling (e.g., signaling transmitted in the resources allocated for WET 320) may be transmitted using a dedicated waveform for energy harvesting. In some examples, the WET signaling waveform may support energy with potential power boosting. For example, a device (e.g., a network entity 105, a UE 115) may support a first transmit power 325-a as an average power for a carrier (e.g., an average for WET and WIT signaling in the channel bandwidth 305). The device may boost the transmit power 325-b for WET signaling above the first transmit power 325-a (e.g., the average transmit power) to increase the power available for energy harvesting in the resources allocated for WET 320. In some cases, the amount of power boosting 330 (e.g., defined as a ratio between the transmit power for WET and the average transmit power for WET and WIT) may be configured to a set value (e.g., +6 decibels (dB), +9 dB) to ensure coverage of energy delivery. In some examples, the power boosting may be based on a configuration of the transmitting device. For example, a network entity 105 (e.g., a base station 140) may FDM WET and WIT transmissions using transmit powers that satisfy a rated output power threshold, power dynamics, or both of a specific class of network entity 105. In some cases, the network may configure multiple WET bands (e.g., sets of contiguous resources allocated for WET 320) in-band. In some such cases, the network entity 105—or a UE 115—may support power boosting one WET band of the multiple WET bands at a time in the channel bandwidth 305.

The waveform for in-band WET signaling may employ an OFDM waveform with a specific SCS. For example, the SCS for the OFDM waveform may support WET signaling on the downlink being orthogonal to WIT signaling (e.g., NR signaling) on the downlink (e.g., within the channel bandwidth 305 or contiguous to the WET signaling in the frequency domain).

As an example, the resources allocated for WET 320 may be contiguous to a first BWP 335-a, a second BWP 335-b, or both. The first BWP 335-a, the second BWP 335-b, or both may be configured for WIT signaling (e.g., NR signaling or other signaling). In some cases, the first BWP 335-a and the second BWP 335-b may use the same SCS. For example, the first BWP 335-a and the second BWP 335-b may be a same BWP or may be different BWPs configured with a same SCS. In some such cases, the WET signaling (e.g., the OFDM waveform for the WET signaling) may use the same SCS as the adjacent BWPs to support signaling in the adjacent BWPs (e.g., the first BWP 335-a and the second BWP 335-b) being orthogonal to the WET signaling in the resources allocated for WET 320. The in-band resource allocation 300 may not include a guard subcarrier (e.g., a guard band) between the resources allocated for WET 320 and the resources allocated for WIT 315 (e.g., in the first BWP 335-a, in the second BWP 335-b) based on the waveform for the WET signaling using a same SCS and being orthogonal to the waveform for the WIT signaling.

In some cases, the network may refrain from configuring the resources allocated for WET 320 between BWPs with different BWP numerologies (e.g., different SCSs). That is, the network may deploy WET in-band according to a set of rules, such that the WET resources use a same SCS as the WIT resources adjacent to the WET resources in the frequency domain.

In some other cases, the first BWP 335-a and the second BWP 335-b may use different SCSs. For example, the first BWP 335-a may be configured with a first BWP numerology corresponding to a first SCS for WIT signaling and the second BWP 335-b may be configured with a second BWP numerology corresponding to a second SCS for WIT signaling. In a first example, the WET signaling (e.g., the OFDM waveform for the WET signaling) may use the same SCS as one of the BWPs, for example, according to a rule (e.g., the WET signaling uses the smaller SCS, the WET signaling uses the larger SCS). Accordingly, the WET signaling may be orthogonal to the WIT signaling in one of the BWPs but not the other. The network may apply a guard subcarrier (e.g., a guard band) between the resources allocated for WET 320 and the resources allocated for WIT 315 of the BWP that is not orthogonal to the WET signaling. For example, if the WET signaling is configured with the first SCS, the network may apply a guard band between the resources allocated for WET 320 and the second BWP 335-b. The guard band may mitigate interference (e.g., inter-numerology interference) between the WET signaling and the WIT signaling in the second BWP 335-b that is non-orthogonal to the WET signaling.

In a second example, the WET signaling (e.g., the OFDM waveform for the WET signaling) may use a third SCS different from the first SCS for the first BWP 335-a and different from the second SCS for the second BWP 335-b. Accordingly, the WET signaling may be non-orthogonal to WIT signaling in both the first BWP 335-a and the second BWP 335-b. The network may apply guard bands between the first BWP 335-a and the resources allocated for WET 320 and between the second BWP 335-b and the resources allocated for WET 320 to mitigate interference (e.g., inter-numerology interference) between the WET signaling and the WIT signaling using different SCSs.

In a third example, the WET signaling (e.g., the OFDM waveform for the WET signaling) may use multiple SCSs. For example, different portions of the WET signaling may use different SCSs. In some cases, a first set of frequency resources of the resources allocated for WET 320 that is adjacent to the first BWP 335-a may use the first SCS (e.g., the same SCS as the first BWP 335-a). Similarly, a second set of frequency resources of the resources allocated for WET 320 that is adjacent to the second BWP 335-b may use the second SCS (e.g., the same SCS as the second BWP 335-b). In some examples, a third set of frequency resources between the first set and second set of frequency resources of the resources allocated for WET 320 may use a third SCS (e.g., an SCS value between the first SCS value and the second SCS value). A device (e.g., a network entity 105) transmitting the WET signaling may apply a reduced transmit power to the WET signaling in the third set of frequency resources to reduce interference with the first BWP 335-a, the second BWP 335-b, or both. In some cases, the device may reduce the transmit power in the third set of frequency resources to zero. Interference (e.g., inter-numerology interference) within the resources allocated for WET 320 may not affect the WET signaling, as the WET signaling is used to carry energy for energy harvesting and is not used for information transfer. The techniques described herein, however, may effectively reduce or mitigate interference from the WET signaling to WIT signaling in neighboring or nearby BWPs.

Additionally, or alternatively, the in-band resource allocation 300 may manage emissions from the WET signaling. WET emissions into adjacent BWPs (e.g., BWPs directly bordering the resources allocated for WET 320 or BWPs separated from the resources allocated for WET 320 by guard bands) may be defined in terms of a spectral emission mask, a total in-band emission (IBE), or both. The network may configure WET signaling such that energy emissions outside the resources allocated for WET 320 may satisfy a threshold (e.g., not exceed the threshold) and may decay for frequencies farther away from the resources allocated for WET 320 (e.g., according to one or more additional emission thresholds). The network may relax IBE thresholds into the resources allocated for WET 320 (e.g., WIT signaling may be allowed to have greater emissions into the resources allocated for WET 320) because interference may not negatively affect WET signaling. However, the network may apply the IBE thresholds out of the resources allocated for WET 320 and into the resources allocated for WIT 315. Additionally, or alternatively, the network may ensure that the total emission from WET signaling and WIT signaling outside of the carrier (e.g., the channel bandwidth 305) satisfies an out-of-band (OOB) threshold, an adjacent channel leakage ratio (ACLR) threshold, or both. Additionally, or alternatively, in a paired spectrum, the emission thresholds may be different for different channels, different devices, or both. For example, UEs 115 and network entities 105 may apply different emission thresholds. Additionally, or alternatively, devices may apply different emission thresholds for uplink channels, downlink channels, sidelink channels, or some combination thereof. In an unpaired spectrum, in some cases, multiple devices (e.g., a network entity 105 and a UE 115) may access the resources allocated for WET 320 concurrently.

The resources allocated for WET 320 may be used for different processes, for example, based on a configuration of the channel, the resources, the devices in the network, or any combination thereof. In some examples, a network entity 105, a UE 115, or both may transmit dedicated energy signals (e.g., optimized or otherwise configured for WET) in the resources allocated for WET 320. For example, a dedicated energy signal may be a multi-sine signal. In some examples, UEs 115 may be scheduled by dedicated energy signals from a network entity 105 (e.g., in paired or unpaired spectrum). In some cases, the resources allocated for WET 320 may be configured for generic WET or for device-specific WET. For example, for generic WET, a device transmitting WET signaling may broadcast the WET signaling, transmit the WET signaling in multiple directions (e.g., using beam sweeping), or transmit the WET signaling in a pseudo-random direction. For device-specific WET, different portions of the resources allocated for WET 320 may be allocated for WET to specific energy harvesting devices. For example, a first subset of frequency resources in the resources allocated for WET 320 may be allocated for energy transfer to a first energy harvesting device, and a second subset of frequency resources in the resources allocated for WET 320 may be allocated for energy transfer to a second energy harvesting device. Accordingly, WET signaling may be transmitted in specific directions in the different subsets of frequency resources to support energy harvesting at specific devices. Additionally, or alternatively, WET signaling for different energy harvesting devices may be TDDed in the resources allocated for WET 320.

In some examples, the WET signaling in the resources allocated for WET 320 may also include information. For example, WET signaling may include NR signaling (e.g., using NR waveforms), NB-IoT signaling, or other information-carrying signaling. Network entities 105, UEs 115, or both may use the WET signaling for communications—potentially at relatively higher transmit powers—while energy harvesting devices may harvest power from the WET signaling.

In some examples, the WET signaling may support transmission of repeated information signals (e.g., NR or NB-IoT signals). A device (e.g., UE 115, network entity 105) may opportunistically receive the WET signaling to recover a missed message, improve communication reliability, improve a decoding success rate, or any combination thereof. Additionally, an energy harvesting device may use the WET signaling for energy harvesting. In some cases, repeated transmissions in the resources allocated for WET 320 may include physical uplink shared channel (PUSCH) transmissions, physical uplink control channel (PUCCH) transmissions, physical downlink shared channel (PDSCH) transmissions, physical downlink control channel (PDCCH) transmissions, physical sidelink shared channel (PSSCH) transmissions, physical sidelink control channel (PSCCH) transmissions, or any other repeated transmissions. The device transmitting a repeated transmission may, in some examples, modify one or more transmit parameters (e.g., transmit power) when opportunistically transmitting the repeated transmission in the resources allocated for WET 320. Additionally, or alternatively, the repeated transmissions may be examples of reference signals to support improved channel estimation, phase noise cancellation, or both. For example, a device may transmit an SSB, a channel state information reference signal (CSI-RS), or another reference signal in the resources allocated for WET 320 to be used for reference signal measurement and energy harvesting.

In some examples, the WET signaling may support signal shaping signals. For example, a network entity 105 may transmit a signal shaping signal on the downlink in the resources allocated for WET 320. Additionally, or alternatively, a UE 115 may transmit a signal shaping signal on the uplink in the resources allocated for WET 320. For example, the resources allocated for WET 320 may be used for tone reservation (TR) for peak-to-average-power ratio (PAPR) reduction, for active interference cancellation (AIC) for emission reduction, or both.

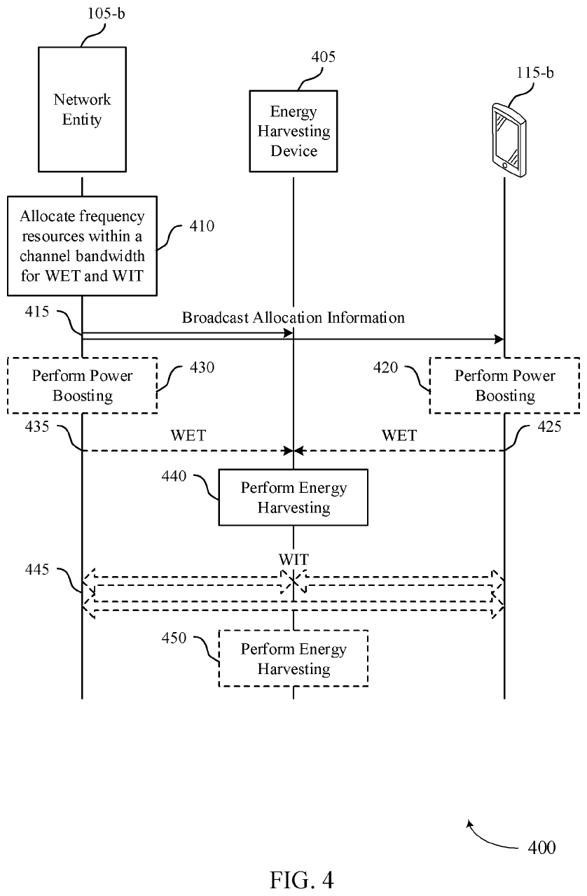

FIG. 4 illustrates an example of a process flow 400 that supports in-band deployment for wireless energy and information transfer in accordance with one or more aspects of the present disclosure. The process flow 400 may implement or be implemented by aspects of a wireless communications system 100, a wireless communications system 200, or both. The process flow 400 may include a UE 115-b, a network entity 105-b, and an energy harvesting device 405 (e.g., an RFID tag, a passive IoT device, another UE 115), which may be examples of a UE 115, a network entity 105, and an energy harvesting device as described herein with reference to FIGS. 1 through 3. For example, the UE 115-b, the network entity 105-b, and the energy harvesting device 405 may operate according to an in-band deployment of WET and WIT signaling (e.g., according to an in-band resource allocation, such as the in-band resource allocation 300 as described with reference to FIG. 3). In the following description of the process flow 400, the operations performed by the devices may be performed in different orders or at different times. Additionally, or alternatively, some operations may be omitted from the process flow 400, and other operations may be added to the process flow 400.

At 410, the network entity 105-b may allocate frequency resources for WET, WIT, or both. For example, the network entity 105-b may allocate, in a cellular network, one or more frequency resources within a channel bandwidth (e.g., in a licensed spectrum) for WET. Additionally, the network entity 105-b may allocate one or more additional frequency resources for WIT (e.g., on an uplink channel, a downlink channel, a sidelink channel, or some combination thereof).

At 415, the network entity 105-b may transmit a broadcast signal indicating the resource allocation (e.g., the resource configuration). For example, the network entity 105-b may broadcast signaling indicating the one or more frequency resources that are configured for WET, the one or more additional frequency resources that are configured for WIT, or both. In some cases, the broadcast signal may be an example of a MIB or a SIB. Additionally, or alternatively, the network entity 105-b may transmit other configuration information for the resource allocation in control signaling, such as a MIB, a SIB, a MAC control element (CE), downlink control information (DCI), or any combination thereof. The broadcast signal may include a bitmap or an index of a bitmap that identifies at least the one or more frequency resources configured for WET. Alternatively, the broadcast signal may indicate respective sets of one or more frequency resources that are configured for WET within respective BWPs.

An energy harvesting device 405 may receive the broadcast signal and determine the resource allocation. For example, the energy harvesting device 405 may receive the broadcast signal indicating the one or more frequency resources within the channel bandwidth that are allocated for WET. Additionally, or alternatively, a UE 115-b (e.g., an energy providing device) may receive the broadcast signal and determine the resource allocation. In some examples, the resources allocated for WET may be allocated for specific energy harvesting devices. For example, a subset of the one or more frequency resources allocated for WET may be allocated for WET specifically to the energy harvesting device 405 (e.g., from a set of multiple energy harvesting devices in a wireless communications system).

In some examples, the UE 115-b may provide energy to the energy harvesting device 405 (e.g., using RF signaling) for energy harvesting. In some cases, at 420, the UE 115-b may perform power boosting. For example, the UE 115-b may power boost a signal for WET based on a power boosting threshold. At 425, the UE 115-b may transmit the signal for WET in the one or more frequency resources allocated for WET (e.g., in accordance with the broadcast signal received at 415).

Additionally, or alternatively, the network entity 105-b may provide energy to the energy harvesting device 405 (e.g., using RF signaling) for energy harvesting. In some cases, at 430, the network entity 105-b may power boost a signal for WET based on a power boosting threshold. At 435, the network entity 105-b may transmit, to the energy harvesting device 405, the signal for WET in the one or more frequency resources allocated for WET (e.g., based on the configuration by the network entity 105-b).

A signal for WET (e.g., from the UE 115-b or from the network entity 105-b) may be an example of a signal dedicated for energy transfer or may be an example of PUCCH signaling, PUSCH signaling, sidelink signaling, signal shaping signaling, PDCCH signaling, PDSCH signaling, or any combination thereof.

At 440, the energy harvesting device 405 may perform energy harvesting. For example, the energy harvesting device 405 may receive a signal within the one or more frequency resources allocated for WET. The signal may be available for WET in accordance with the broadcast signal received at 415. The energy harvesting device 405 may receive signaling for WET from the UE 115-b (e.g., at 425), from the network entity 105-b (e.g., at 435), or both. The energy harvesting device 405 may perform energy harvesting using the signal received within the one or more frequency resources allocated for WET.

In some cases, the energy harvesting device 405 may additionally perform energy harvesting using one or more additional signals received outside of the one or more frequency resources allocated for WET (e.g., where the one or more additional signals may be WIT signaling). For example, at 445, the devices may communicate using WIT signaling. For example, the network entity 105-b may communicate with the energy harvesting device 405, the UE 115-b, or both. Additionally, or alternatively, the energy harvesting device 405 may communicate with the UE 115-b. At 450, in some cases, the energy harvesting device 405 may perform additional energy harvesting using WIT signaling detected by the energy harvesting device 405.

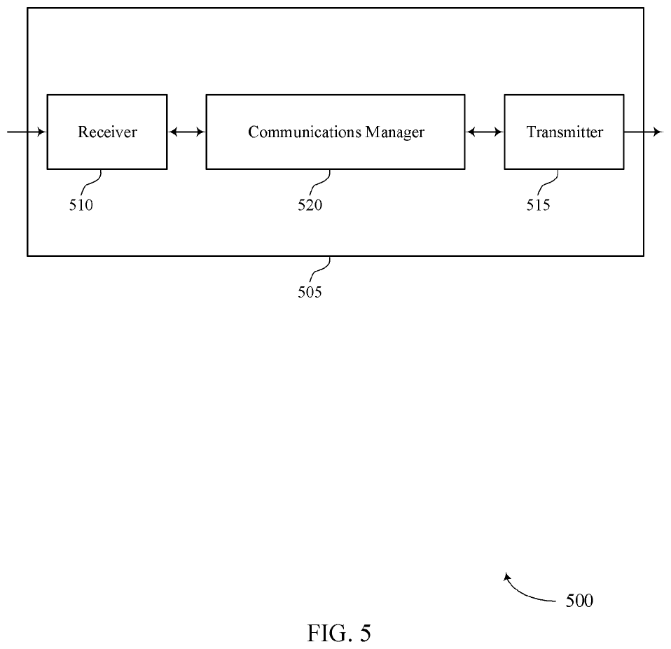

FIG. 5 shows a block diagram 500 of a device 505 that supports in-band deployment for wireless energy and information transfer in accordance with one or more aspects of the present disclosure. The device 505 may be an example of aspects of an energy harvesting device, a UE 115, or both as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to in-band deployment for wireless energy and information transfer). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to in-band deployment for wireless energy and information transfer). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of in-band deployment for wireless energy and information transfer as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 may be configured as or otherwise support a means for receiving, in a cellular network, a broadcast signal indicating one or more frequency resources within a channel bandwidth that are allocated for wireless energy transfer. The communications manager 520 may be configured as or otherwise support a means for receiving a signal within the one or more frequency resources, the signal being available for wireless energy transfer in accordance with the broadcast signal. The communications manager 520 may be configured as or otherwise support a means for performing energy harvesting using the signal received within the one or more frequency resources allocated for wireless energy transfer.

Additionally, or alternatively, the communications manager 520 may support wireless communications in accordance with examples as disclosed herein. For example, the communications manager 520 may be configured as or otherwise support a means for receiving, in a cellular network, a broadcast signal indicating one or more frequency resources within a channel bandwidth that are allocated for wireless energy transfer. The communications manager 520 may be configured as or otherwise support a means for transmitting a signal for wireless energy transfer in the one or more frequency resources in accordance with the broadcast signal.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for powering a processor of the device 505. For example, the device 505 may perform energy harvesting using WET signaling, which may support a relatively greater power density than ambient RF signaling (e.g., WIT signaling). As such, the device 505 may harvest enough energy to power a processor at the device 505, charge a battery at the device 505, perform one or more operations at the device 505, or any combination thereof.

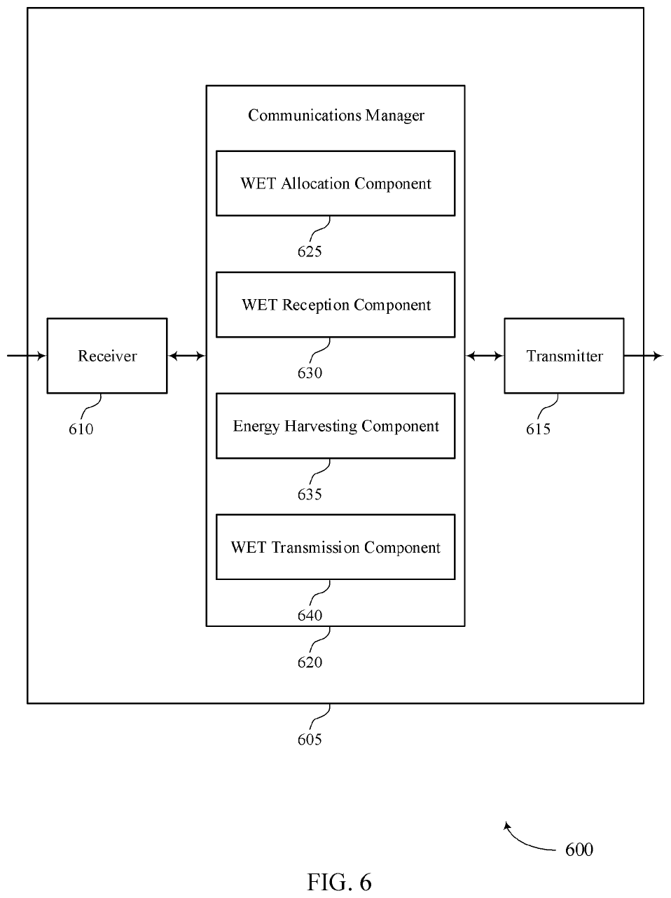

FIG. 6 shows a block diagram 600 of a device 605 that supports in-band deployment for wireless energy and information transfer in accordance with one or more aspects of the present disclosure. The device 605 may be an example of aspects of a device 505, an energy harvesting device, a UE 115, or any combination thereof as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to in-band deployment for wireless energy and information transfer). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to in-band deployment for wireless energy and information transfer). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of in-band deployment for wireless energy and information transfer as described herein. For example, the communications manager 620 may include a WET allocation component 625, a WET reception component 630, an energy harvesting component 635, a WET transmission component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The WET allocation component 625 may be configured as or otherwise support a means for receiving, in a cellular network, a broadcast signal indicating one or more frequency resources within a channel bandwidth that are allocated for wireless energy transfer. The WET reception component 630 may be configured as or otherwise support a means for receiving a signal within the one or more frequency resources, the signal being available for wireless energy transfer in accordance with the broadcast signal. The energy harvesting component 635 may be configured as or otherwise support a means for performing energy harvesting using the signal received within the one or more frequency resources allocated for wireless energy transfer.

Additionally, or alternatively, the communications manager 620 may support wireless communications in accordance with examples as disclosed herein. The WET allocation component 625 may be configured as or otherwise support a means for receiving, in a cellular network, a broadcast signal indicating one or more frequency resources within a channel bandwidth that are allocated for wireless energy transfer. The WET transmission component 640 may be configured as or otherwise support a means for transmitting a signal for wireless energy transfer in the one or more frequency resources in accordance with the broadcast signal.

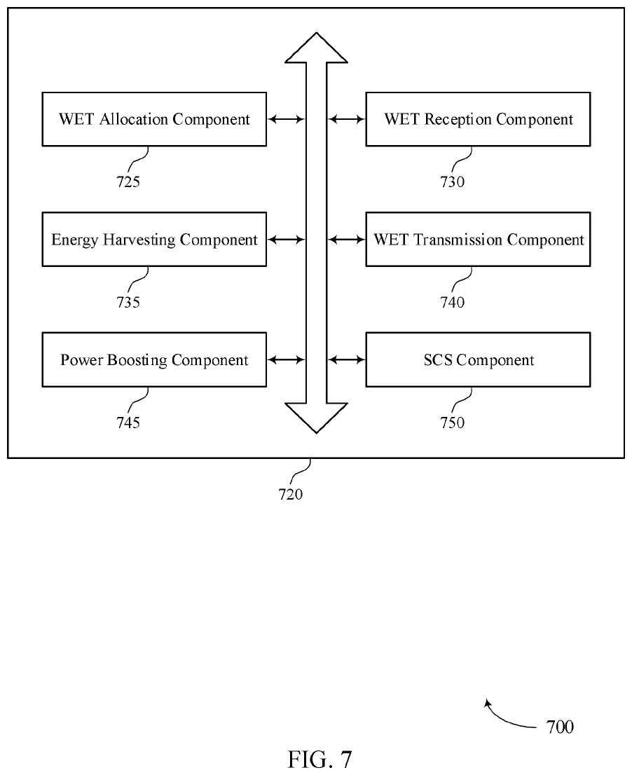

FIG. 7 shows a block diagram 700 of a communications manager 720 that supports in-band deployment for wireless energy and information transfer in accordance with one or more aspects of the present disclosure. The communications manager 720 may be an example of aspects of a communications manager 520, a communications manager 620, or both, as described herein. The communications manager 720, or various components thereof, may be an example of means for performing various aspects of in-band deployment for wireless energy and information transfer as described herein. For example, the communications manager 720 may include a WET allocation component 725, a WET reception component 730, an energy harvesting component 735, a WET transmission component 740, a power boosting component 745, an SCS component 750, or any combination thereof. Each of these components may communicate, directly or indirectly, with one another (e.g., via one or more buses).

The communications manager 720 may support wireless communications in accordance with examples as disclosed herein. The WET allocation component 725 may be configured as or otherwise support a means for receiving, in a cellular network, a broadcast signal indicating one or more frequency resources within a channel bandwidth that are allocated for wireless energy transfer. The WET reception component 730 may be configured as or otherwise support a means for receiving a signal within the one or more frequency resources, the signal being available for wireless energy transfer in accordance with the broadcast signal. The energy harvesting component 735 may be configured as or otherwise support a means for performing energy harvesting using the signal received within the one or more frequency resources allocated for wireless energy transfer.

In some examples, the energy harvesting component 735 may be configured as or otherwise support a means for performing additional energy harvesting using one or more additional signals received outside of the one or more frequency resources, the one or more additional signals being for wireless information transfer.

In some examples, to support receiving the broadcast signal, the WET allocation component 725 may be configured as or otherwise support a means for receiving a MIB, a SIB, or both, where the MIB, the SIB, or a combination thereof indicates the one or more frequency resources.

In some examples, to support receiving the broadcast signal, the WET allocation component 725 may be configured as or otherwise support a means for receiving a bitmap or an index of a bitmap that identifies the one or more frequency resources. In some examples, the broadcast signal indicates respective sets of one or more frequency resources that are configured for wireless energy transfer within respective bandwidth parts.

In some examples, the channel bandwidth corresponds to a licensed spectrum.

Additionally, or alternatively, the communications manager 720 may support wireless communications in accordance with examples as disclosed herein. In some examples, the WET allocation component 725 may be configured as or otherwise support a means for receiving, in a cellular network, a broadcast signal indicating one or more frequency resources within a channel bandwidth that are allocated for wireless energy transfer. The WET transmission component 740 may be configured as or otherwise support a means for transmitting a signal for wireless energy transfer in the one or more frequency resources in accordance with the broadcast signal.

In some examples, the power boosting component 745 may be configured as or otherwise support a means for power boosting the signal for wireless energy transfer based on a power boosting threshold.

In some examples, the WET allocation component 725 may be configured as or otherwise support a means for determining that a subset of the one or more frequency resources is allocated for wireless energy transfer to an energy harvesting device of a set of multiple energy harvesting devices, where the signal for wireless energy transfer is transmitted to the energy harvesting device in the subset of the one or more frequency resources.

In some examples, the SCS component 750 may be configured as or otherwise support a means for receiving control signaling indicating an SCS to use for the signal for wireless energy transfer, the control signaling including a MIB, a SIB, RRC signaling, a MAC-CE, DCI, or a combination thereof, where the signal for wireless energy transfer is transmitted further based on the SCS.

In some examples, the channel bandwidth includes a first BWP preceding the one or more frequency resources in a frequency domain and a second BWP following the one or more frequency resources in the frequency domain, the first BWP and the second BWP corresponding to a same SCS. In some such examples, the signal for wireless energy transfer includes an OFDM waveform with the same SCS as the first BWP and the second BWP.

In some examples, the channel bandwidth includes a first BWP preceding the one or more frequency resources in a frequency domain and a second BWP following the one or more frequency resources in the frequency domain, the first BWP corresponding to a first SCS and the second BWP corresponding to a second SCS. In some such examples, the signal for wireless energy transfer includes an OFDM waveform with the first SCS, and the signal for wireless energy transfer is separated from the second BWP in the frequency domain by a guard band. In some other such examples, the signal for wireless energy transfer includes the OFDM waveform with the second SCS, and the signal for wireless energy transfer is separated from the first BWP in the frequency domain by the guard band.

In some examples, the channel bandwidth includes a first BWP preceding the one or more frequency resources in a frequency domain and a second BWP following the one or more frequency resources in the frequency domain, the first BWP corresponding to a first SCS and the second BWP corresponding to a second SCS. In some such examples, the signal for wireless energy transfer includes an OFDM waveform with a third SCS different from the first SCS and the second SCS, where the signal for wireless energy transfer is separated from the first BWP in the frequency domain by a first guard band and is separated from the second BWP in the frequency domain by a second guard band.

In some examples, the channel bandwidth includes a first BWP preceding the one or more frequency resources in a frequency domain and a second BWP following the one or more frequency resources in the frequency domain, the first BWP corresponding to a first SCS and the second BWP corresponding to a second SCS. In some examples, the signal for wireless energy transfer includes an OFDM waveform with a set of multiple SCSs including at least the first SCS in a first portion adjacent to the first BWP in the frequency domain and the second SCS in a second portion adjacent to the second BWP in the frequency domain.

In some examples, the signal for wireless energy transfer is dedicated for energy transfer or includes PUCCH signaling, PUSCH signaling, sidelink signaling, signal shaping signaling, or a combination thereof.

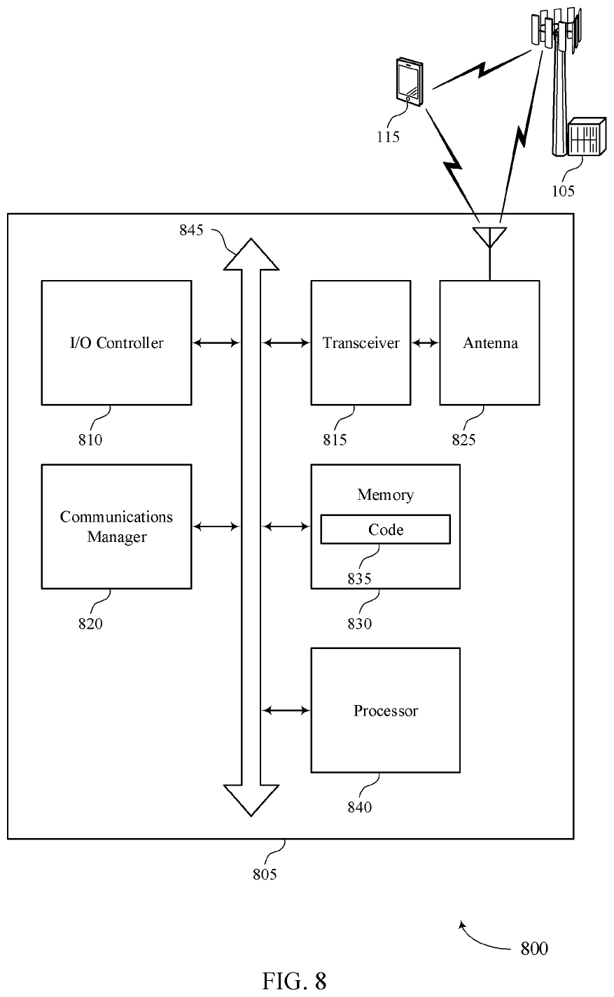

FIG. 8 shows a diagram of a system 800 including a device 805 that supports in-band deployment for wireless energy and information transfer in accordance with one or more aspects of the present disclosure. The device 805 may be an example of or include the components of a device 505, a device 605, an energy harvesting device, a UE 115, or any combination thereof as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting in-band deployment for wireless energy and information transfer). For example, the device 805 or a component of the device 805 may include a processor 840 and memory 830 coupled with or to the processor 840, the processor 840 and memory 830 configured to perform various functions described herein.

The communications manager 820 may support wireless communications in accordance with examples as disclosed herein. For example, the communications manager 820 may be configured as or otherwise support a means for receiving, in a cellular network, a broadcast signal indicating one or more frequency resources within a channel bandwidth that are allocated for wireless energy transfer. The communications manager 820 may be configured as or otherwise support a means for receiving a signal within the one or more frequency resources, the signal being available for wireless energy transfer in accordance with the broadcast signal. The communications manager 820 may be configured as or otherwise support a means for performing energy harvesting using the signal received within the one or more frequency resources allocated for wireless energy transfer.

Additionally, or alternatively, the communications manager 820 may support wireless communications in accordance with examples as disclosed herein. For example, the communications manager 820 may be configured as or otherwise support a means for receiving, in a cellular network, a broadcast signal indicating one or more frequency resources within a channel bandwidth that are allocated for wireless energy transfer. The communications manager 820 may be configured as or otherwise support a means for transmitting a signal for wireless energy transfer in the one or more frequency resources in accordance with the broadcast signal.

By including or configuring the communications manager 820 in accordance with examples as described herein, the device 805 may support techniques for improved communication reliability, extended battery life, or both. For example, the device 805 (e.g., an energy harvesting device) may harvest energy from WET signaling in resources configured for WET. This energy harvesting may allow the device 805 to remain in a powered-on state (e.g., by charging a battery at the device 805, powering circuitry at the device 805). Accordingly, the device 805 may maintain a network connection, perform communications, or perform other processes using the power obtained via the energy harvesting, improving communication reliability and operations within a wireless communications system.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of in-band deployment for wireless energy and information transfer as described herein, or the processor 840 and the memory 830 may be otherwise configured to perform or support such operations.

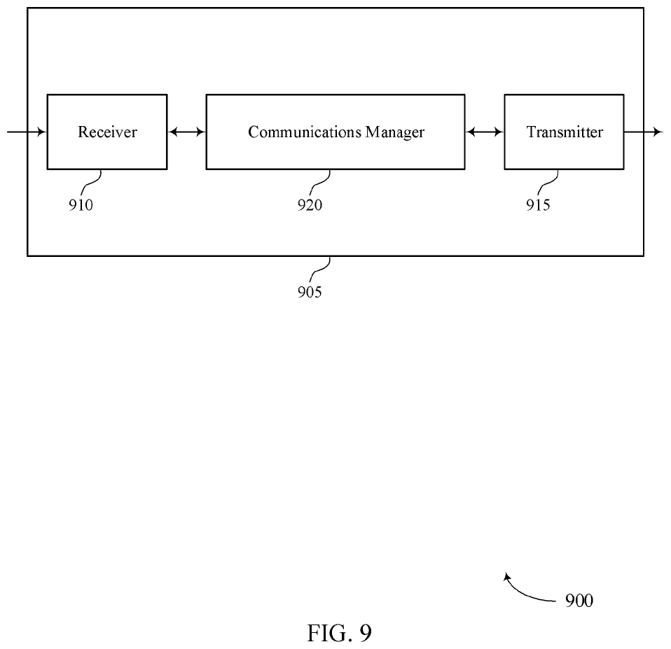

FIG. 9 shows a block diagram 900 of a device 905 that supports in-band deployment for wireless energy and information transfer in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of in-band deployment for wireless energy and information transfer as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 may be configured as or otherwise support a means for allocating, in a cellular network, one or more frequency resources within a channel bandwidth for wireless energy transfer. The communications manager 920 may be configured as or otherwise support a means for transmitting a broadcast signal indicating the one or more frequency resources that are configured for wireless energy transfer.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources. For example, the device 905 may configure in-band resources for WET, WIT, or both. As such, the device 905 may support charging energy harvesting devices in a wireless communications system while mitigating potential negative effects on other signaling (e.g., WIT signaling) in the system.

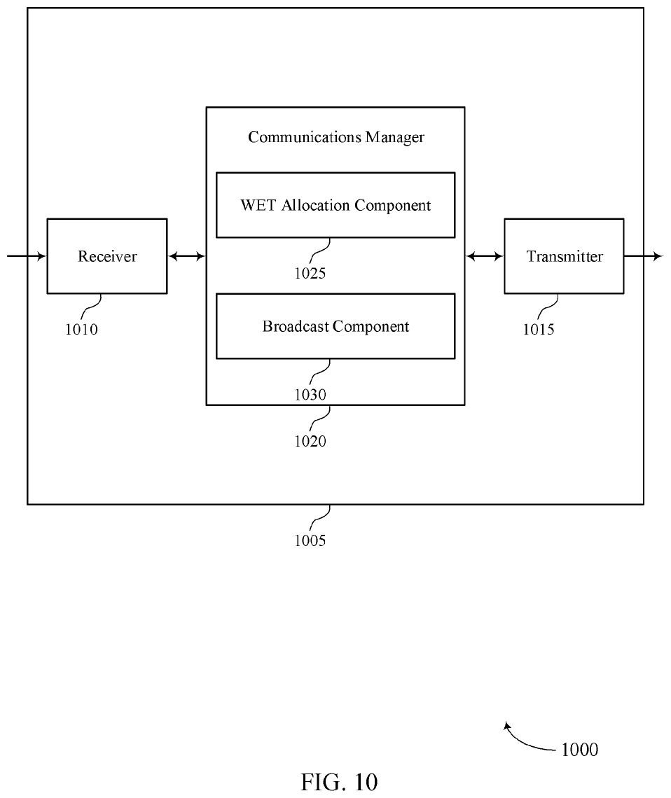

FIG. 10 shows a block diagram 1000 of a device 1005 that supports in-band deployment for wireless energy and information transfer in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of in-band deployment for wireless energy and information transfer as described herein. For example, the communications manager 1020 may include a WET allocation component 1025, a broadcast component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The WET allocation component 1025 may be configured as or otherwise support a means for allocating, in a cellular network, one or more frequency resources within a channel bandwidth for wireless energy transfer. The broadcast component 1030 may be configured as or otherwise support a means for transmitting a broadcast signal indicating the one or more frequency resources that are configured for wireless energy transfer.

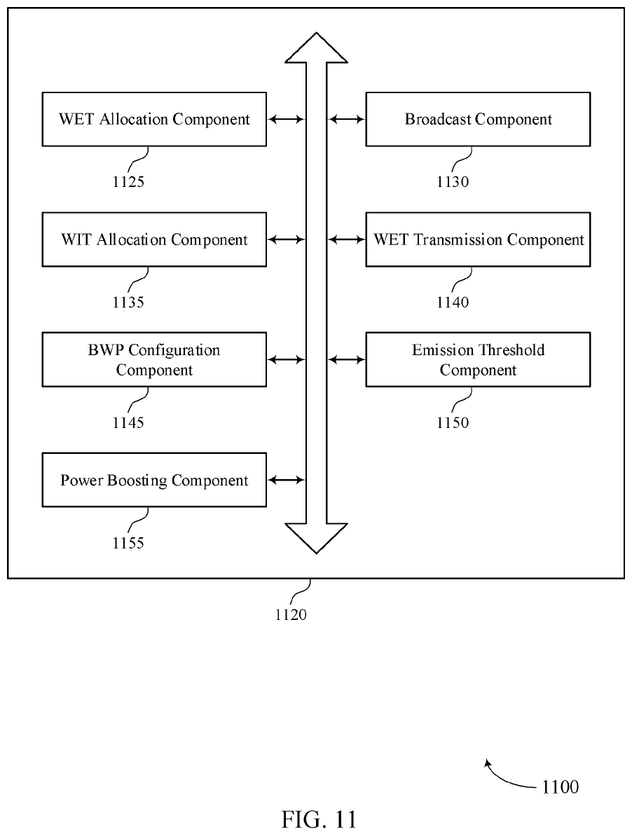

FIG. 11 shows a block diagram 1100 of a communications manager 1120 that supports in-band deployment for wireless energy and information transfer in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of in-band deployment for wireless energy and information transfer as described herein. For example, the communications manager 1120 may include a WET allocation component 1125, a broadcast component 1130, a WIT allocation component 1135, a WET transmission component 1140, a BWP configuration component 1145, an emission threshold component 1150, a power boosting component 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The WET allocation component 1125 may be configured as or otherwise support a means for allocating, in a cellular network, one or more frequency resources within a channel bandwidth for wireless energy transfer. The broadcast component 1130 may be configured as or otherwise support a means for transmitting a broadcast signal indicating the one or more frequency resources that are configured for wireless energy transfer.

In some examples, the WIT allocation component 1135 may be configured as or otherwise support a means for allocating one or more additional frequency resources within the channel bandwidth for wireless information transfer on an uplink channel, a downlink channel, or both. In some examples, the broadcast signal further indicates the one or more additional frequency resources that are allocated for wireless information transfer, the broadcast signal including a MIB, a SIB, or both.

In some examples, the WET transmission component 1140 may be configured as or otherwise support a means for transmitting, to an energy harvesting device, a signal for wireless energy transfer in the one or more frequency resources based on the allocated one or more frequency resources.

In some examples, the power boosting component 1155 may be configured as or otherwise support a means for power boosting the signal for wireless energy transfer based on a power boosting threshold. In some examples, the power boosting component 1155 may be configured as or otherwise support a means for selecting a first set of contiguous frequency resources of the one or more frequency resources for power boosting the signal for wireless energy transfer, where the signal for wireless energy transfer is power boosted in the first set of contiguous frequency resources based on the selecting. In some such examples, the power boosting component 1155 may be configured as or otherwise support a means for refraining from power boosting the signal for wireless energy transfer in a second set of contiguous frequency resources of the one or more frequency resources.

In some examples, the signal for wireless energy transfer is dedicated for energy transfer or includes PDCCH signaling, PDSCH signaling, reference signaling, signal shaping signaling, or a combination thereof.

In some examples, to support allocating the one or more frequency resources for wireless energy transfer, the WET allocation component 1125 may be configured as or otherwise support a means for allocating a first subset of the one or more frequency resources for wireless energy transfer to a first energy harvesting device of a set of multiple energy harvesting devices. In some examples, to support allocating the one or more frequency resources for wireless energy transfer, the WET allocation component 1125 may be configured as or otherwise support a means for allocating a second subset of the one or more frequency resources for wireless energy transfer to a second energy harvesting device of the set of multiple energy harvesting devices. In some examples, the broadcast signal includes a MIB, a SIB, or both.

In some examples, the BWP configuration component 1145 may be configured as or otherwise support a means for configuring the channel bandwidth with a first BWP corresponding to an SCS and preceding the one or more frequency resources in a frequency domain. In some such examples, the BWP configuration component 1145 may be configured as or otherwise support a means for configuring the channel bandwidth with a second BWP corresponding to the SCS and following the one or more frequency resources in the frequency domain.

In some examples, the emission threshold component 1150 may be configured as or otherwise support a means for applying, to first signaling transmitted in the one or more frequency resources that are configured for wireless energy transfer, an emission threshold associated with the first signaling affecting frequency resources outside the one or more frequency resources. In some examples, the emission threshold component 1150 may be configured as or otherwise support a means for refraining from applying, to second signaling transmitted in the frequency resources outside the one or more frequency resources that are configured for wireless energy transfer, the emission threshold associated with the second signaling affecting the one or more frequency resources.

In some examples, the emission threshold component 1150 may be configured as or otherwise support a means for applying a total emission threshold associated with both first signaling for wireless energy transfer and second signaling for wireless information transfer affecting frequency resources outside the channel bandwidth.

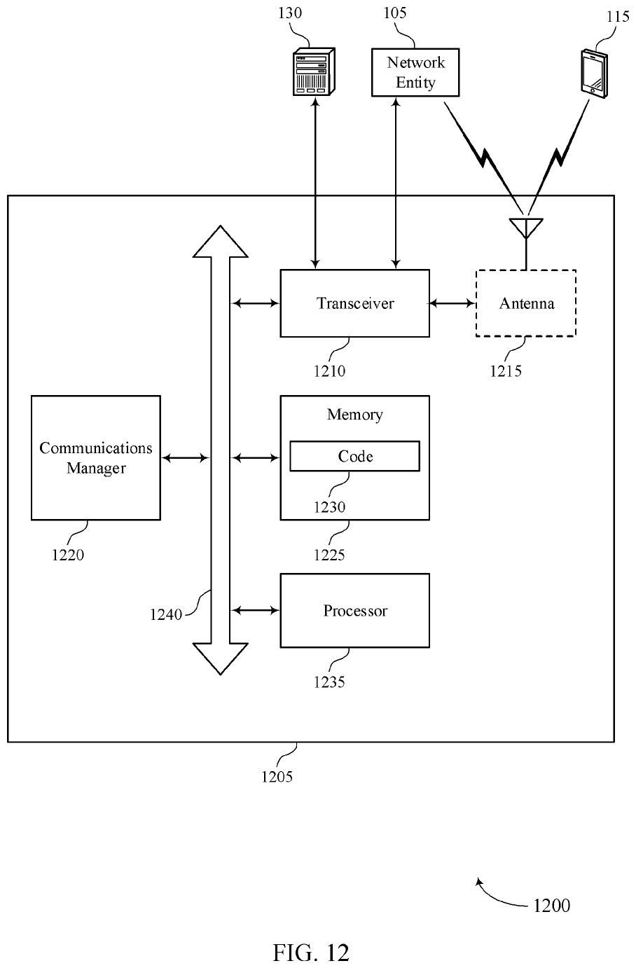

FIG. 12 shows a diagram of a system 1200 including a device 1205 that supports in-band deployment for wireless energy and information transfer in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting in-band deployment for wireless energy and information transfer). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105 and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 may be configured as or otherwise support a means for allocating, in a cellular network, one or more frequency resources within a channel bandwidth for wireless energy transfer. The communications manager 1220 may be configured as or otherwise support a means for transmitting a broadcast signal indicating the one or more frequency resources that are configured for wireless energy transfer.

By including or configuring the communications manager 1220 in accordance with examples as described herein, the device 1205 may support techniques for more efficient utilization of communication resources. For example, the device 1205 may configure a channel bandwidth to support both WET and WIT signaling, such that devices may communication information in the channel bandwidth while also providing energy for energy harvesting devices in the channel bandwidth. The device 1205 may reduce interference between WET signaling and WIT signaling based on the configuration of the frequency resources allocated for WET.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of in-band deployment for wireless energy and information transfer as described herein, or the processor 1235 and the memory 1225 may be otherwise configured to perform or support such operations.

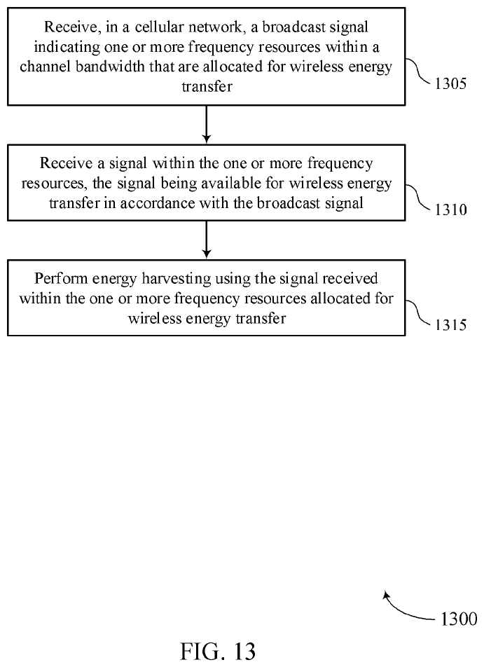

FIG. 13 shows a flowchart illustrating a method 1300 that supports in-band deployment for wireless energy and information transfer in accordance with one or more aspects of the present disclosure. The operations of the method 1300 may be implemented by an energy harvesting device (e.g., an RFID tag, a passive IoT device, a UE 115) or its components as described herein. For example, the operations of the method 1300 may be performed by an energy harvesting device as described with reference to FIGS. 1 through 8. In some examples, an energy harvesting device may execute a set of instructions to control the functional elements of the energy harvesting device to perform the described functions. Additionally, or alternatively, the energy harvesting device may perform aspects of the described functions using special-purpose hardware.

At 1305, the method may include receiving, in a cellular network, a broadcast signal indicating one or more frequency resources within a channel bandwidth that are allocated for wireless energy transfer. The operations of 1305 may be performed in accordance with examples as disclosed herein. In some examples, aspects of the operations of 1305 may be performed by a WET allocation component 725 as described with reference to FIG. 7.

At 1310, the method may include receiving a signal within the one or more frequency resources, the signal being available for wireless energy transfer in accordance with the broadcast signal. The operations of 1310 may be performed in accordance with examples as disclosed herein. In some examples, aspects of the operations of 1310 may be performed by a WET reception component 730 as described with reference to FIG. 7.

At 1315, the method may include performing energy harvesting using the signal received within the one or more frequency resources allocated for wireless energy transfer. The operations of 1315 may be performed in accordance with examples as disclosed herein. In some examples, aspects of the operations of 1315 may be performed by an energy harvesting component 735 as described with reference to FIG. 7.

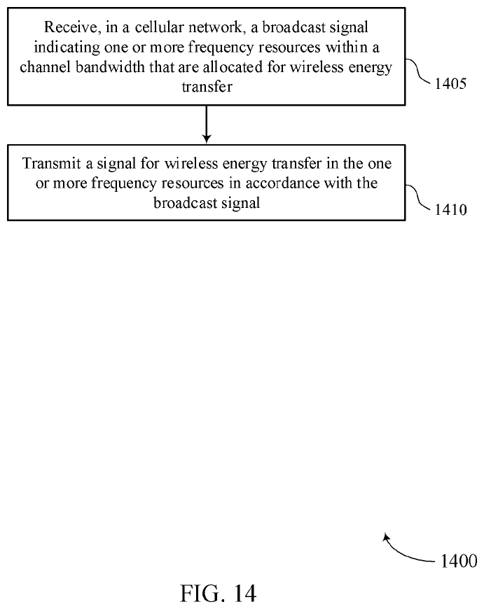

FIG. 14 shows a flowchart illustrating a method 1400 that supports in-band deployment for wireless energy and information transfer in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, in a cellular network, a broadcast signal indicating one or more frequency resources within a channel bandwidth that are allocated for wireless energy transfer. The operations of 1405 may be performed in accordance with examples as disclosed herein. In some examples, aspects of the operations of 1405 may be performed by a WET allocation component 725 as described with reference to FIG. 7.

At 1410, the method may include transmitting a signal for wireless energy transfer in the one or more frequency resources in accordance with the broadcast signal. The operations of 1410 may be performed in accordance with examples as disclosed herein. In some examples, aspects of the operations of 1410 may be performed by a WET transmission component 740 as described with reference to FIG. 7.

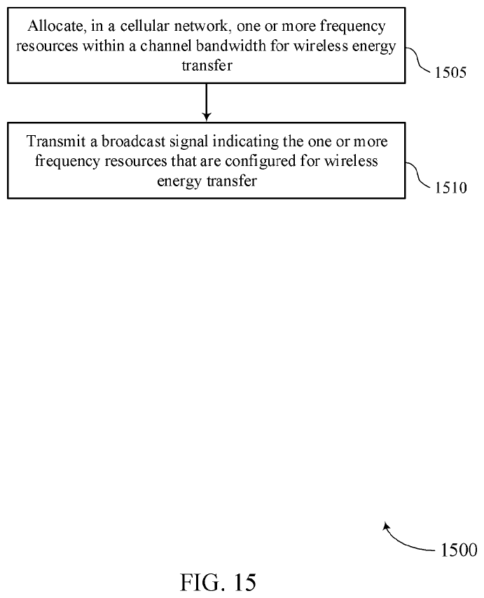

FIG. 15 shows a flowchart illustrating a method 1500 that supports in-band deployment for wireless energy and information transfer in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include allocating, in a cellular network, one or more frequency resources within a channel bandwidth for wireless energy transfer. The operations of 1505 may be performed in accordance with examples as disclosed herein. In some examples, aspects of the operations of 1505 may be performed by a WET allocation component 1125 as described with reference to FIG. 11.

At 1510, the method may include transmitting a broadcast signal indicating the one or more frequency resources that are configured for wireless energy transfer. The operations of 1510 may be performed in accordance with examples as disclosed herein. In some examples, aspects of the operations of 1510 may be performed by a broadcast component 1130 as described with reference to FIG. 11.

The following provides an overview of aspects of the present disclosure:

Aspect 1: A method for wireless communications, comprising: receiving, in a cellular network, a broadcast signal indicating one or more frequency resources within a channel bandwidth that are allocated for WET; receiving a signal within the one or more frequency resources, the signal being available for WET in accordance with the broadcast signal; and performing energy harvesting using the signal received within the one or more frequency resources allocated for WET.

Aspect 2: The method of aspect 1, further comprising: performing additional energy harvesting using one or more additional signals received outside of the one or more frequency resources, the one or more additional signals being for WIT.

Aspect 3: The method of any of aspects 1 through 2, wherein receiving the broadcast signal comprises: receiving a MIB, a SIB, or both, wherein the MIB, the SIB, or a combination thereof indicates the one or more frequency resources.

Aspect 4: The method of any of aspects 1 through 3, wherein receiving the broadcast signal comprises: receiving a bitmap or an index of a bitmap that identifies the one or more frequency resources.

Aspect 5: The method of any of aspects 1 through 4, wherein the broadcast signal indicates respective sets of one or more frequency resources that are configured for WET within respective BWPs.

Aspect 6: The method of any of aspects 1 through 5, wherein the channel bandwidth corresponds to a licensed spectrum.

Aspect 7: A method for wireless communications, comprising: receiving, in a cellular network, a broadcast signal indicating one or more frequency resources within a channel bandwidth that are allocated for WET; and transmitting a signal for WET in the one or more frequency resources in accordance with the broadcast signal.

Aspect 8: The method of aspect 7, further comprising: power boosting the signal for WET based at least in part on a power boosting threshold.

Aspect 9: The method of any of aspects 7 through 8, further comprising: determining that a subset of the one or more frequency resources is allocated for WET to an energy harvesting device of a plurality of energy harvesting devices, wherein the signal for WET is transmitted to the energy harvesting device in the subset of the one or more frequency resources.

Aspect 10: The method of any of aspects 7 through 9, further comprising: receiving control signaling indicating an SCS to use for the signal for WET, the control signaling comprising a MIB, a SIB, RRC signaling, a MAC-CE, DCI, or a combination thereof, wherein the signal for WET is transmitted further based at least in part on the SCS.

Aspect 11: The method of any of aspects 7 through 10, wherein the channel bandwidth comprises a first BWP preceding the one or more frequency resources in a frequency domain and a second BWP following the one or more frequency resources in the frequency domain, the first BWP and the second BWP corresponding to a same SCS; and the signal for WET comprises an OFDM waveform with the same SCS as the first BWP and the second BWP.

Aspect 12: The method of any of aspects 7 through 10, wherein the channel bandwidth comprises a first BWP preceding the one or more frequency resources in a frequency domain and a second BWP following the one or more frequency resources in the frequency domain, the first BWP corresponding to a first SCS and the second BWP corresponding to a second SCS; and the signal for WET comprises an OFDM waveform with the first SCS, and the signal for WET is separated from the second BWP in the frequency domain by a guard band; or the signal for WET comprises the OFDM waveform with the second SCS, and the signal for WET is separated from the first BWP in the frequency domain by the guard band.

Aspect 13: The method of any of aspects 7 through 10, wherein the channel bandwidth comprises a first BWP preceding the one or more frequency resources in a frequency domain and a second BWP following the one or more frequency resources in the frequency domain, the first BWP corresponding to a first SCS and the second BWP corresponding to a second SCS; and the signal for WET comprises an OFDM waveform with a third SCS different from the first SCS and the second SCS, and wherein the signal for WET is separated from the first BWP in the frequency domain by a first guard band and is separated from the second BWP in the frequency domain by a second guard band.

Aspect 14: The method of any of aspects 7 through 10, wherein the channel bandwidth comprises a first BWP preceding the one or more frequency resources in a frequency domain and a second BWP following the one or more frequency resources in the frequency domain, the first BWP corresponding to a first SCS and the second BWP corresponding to a second SCS; and the signal for WET comprises an OFDM waveform with a plurality of SCSs comprising at least the first SCS in a first portion adjacent to the first BWP in the frequency domain and the second SCS in a second portion adjacent to the second BWP in the frequency domain.

Aspect 15: The method of any of aspects 7 through 14, wherein the signal for WET is dedicated for energy transfer or comprises PUCCH signaling, PUSCH signaling, sidelink signaling, signal shaping signaling, or a combination thereof.

Aspect 16: A method for wireless communications, comprising: allocating, in a cellular network, one or more frequency resources within a channel bandwidth for WET; and transmitting a broadcast signal indicating the one or more frequency resources that are configured for WET.

Aspect 17: The method of aspect 16, further comprising: allocating one or more additional frequency resources within the channel bandwidth for WIT on an uplink channel, a downlink channel, or both.

Aspect 18: The method of aspect 17, wherein the broadcast signal further indicates the one or more additional frequency resources that are allocated for WIT, the broadcast signal comprising a MIB, a SIB, or both.

Aspect 19: The method of any of aspects 16 through 18, further comprising: transmitting, to an energy harvesting device, a signal for WET in the one or more frequency resources based at least in part on the allocated one or more frequency resources.

Aspect 20: The method of aspect 19, further comprising: power boosting the signal for WET based at least in part on a power boosting threshold.

Aspect 21: The method of aspect 20, further comprising: selecting a first set of contiguous frequency resources of the one or more frequency resources for power boosting the signal for WET, wherein the signal for WET is power boosted in the first set of contiguous frequency resources based at least in part on the selecting; and refraining from power boosting the signal for WET in a second set of contiguous frequency resources of the one or more frequency resources.

Aspect 22: The method of any of aspects 19 through 21, wherein the signal for WET is dedicated for energy transfer or comprises PDCCH signaling, PDSCH signaling, reference signaling, signal shaping signaling, or a combination thereof.

Aspect 23: The method of any of aspects 16 through 22, wherein allocating the one or more frequency resources for WET further comprises: allocating a first subset of the one or more frequency resources for WET to a first energy harvesting device of a plurality of energy harvesting devices; and allocating a second subset of the one or more frequency resources for WET to a second energy harvesting device of the plurality of energy harvesting devices.

Aspect 24: The method of any of aspects 16 through 23, wherein the broadcast signal comprises a MIB, a SIB, or both.

Aspect 25: The method of any of aspects 16 through 24, further comprising: configuring the channel bandwidth with a first BWP corresponding to an SCS and preceding the one or more frequency resources in a frequency domain; and configuring the channel bandwidth with a second BWP corresponding to the SCS and following the one or more frequency resources in the frequency domain.

Aspect 26: The method of any of aspects 16 through 25, further comprising: applying, to first signaling transmitted in the one or more frequency resources that are configured for WET, an emission threshold associated with the first signaling affecting frequency resources outside the one or more frequency resources; and refraining from applying, to second signaling transmitted in the frequency resources outside the one or more frequency resources that are configured for WET, the emission threshold associated with the second signaling affecting the one or more frequency resources.

Aspect 27: The method of any of aspects 16 through 26, further comprising: applying a total emission threshold associated with both first signaling for WET and second signaling for WIT affecting frequency resources outside the channel bandwidth.

Aspect 28: An apparatus for wireless communications, comprising a processor; memory coupled with the processor; and instructions stored in the memory and executable by the processor to cause the apparatus to perform a method of any of aspects 1 through 6.

Aspect 29: An apparatus for wireless communications, comprising at least one means for performing a method of any of aspects 1 through 6.

Aspect 30: A non-transitory computer-readable medium storing code for wireless communications, the code comprising instructions executable by a processor to perform a method of any of aspects 1 through 6.

Aspect 31: An apparatus for wireless communications, comprising a processor; memory coupled with the processor; and instructions stored in the memory and executable by the processor to cause the apparatus to perform a method of any of aspects 7 through 15.

Aspect 32: An apparatus for wireless communications, comprising at least one means for performing a method of any of aspects 7 through 15.

Aspect 33: A non-transitory computer-readable medium storing code for wireless communications, the code comprising instructions executable by a processor to perform a method of any of aspects 7 through 15.

Aspect 34: An apparatus for wireless communications, comprising a processor; memory coupled with the processor; and instructions stored in the memory and executable by the processor to cause the apparatus to perform a method of any of aspects 16 through 27.

Aspect 35: An apparatus for wireless communications, comprising at least one means for performing a method of any of aspects 16 through 27.

Aspect 36: A non-transitory computer-readable medium storing code for wireless communications, the code comprising instructions executable by a processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
a processor;
memory coupled with the processor; and
instructions stored in the memory and executable by the processor to cause the apparatus to:
receive, in a cellular network, a broadcast signal indicating one or more frequency resources within a channel bandwidth that are allocated for wireless energy transfer;
receive a signal within the one or more frequency resources, the signal being available for wireless energy transfer in accordance with the broadcast signal; and
perform energy harvesting using the signal received within the one or more frequency resources allocated for wireless energy transfer.

2. The apparatus of claim 1, wherein the instructions are further executable by the processor to cause the apparatus to:
perform additional energy harvesting using one or more additional signals received outside of the one or more frequency resources, the one or more additional signals being for wireless information transfer.

3. The apparatus of claim 1, wherein the instructions to receive the broadcast signal are executable by the processor to cause the apparatus to:
receive a master information block, a system information block, or both, wherein the master information block, the system information block, or a combination thereof indicates the one or more frequency resources.

4. The apparatus of claim 1, wherein the instructions to receive the broadcast signal are executable by the processor to cause the apparatus to:
receive a bitmap or an index of a bitmap that identifies the one or more frequency resources.

5. The apparatus of claim 1, wherein the broadcast signal indicates respective sets of one or more frequency resources that are configured for wireless energy transfer within respective bandwidth parts.

6. The apparatus of claim 1, wherein the channel bandwidth corresponds to a licensed spectrum.

7. An apparatus for wireless communications, comprising:
a processor;
memory coupled with the processor; and
instructions stored in the memory and executable by the processor to cause the apparatus to:
receive, in a cellular network, a broadcast signal indicating one or more frequency resources within a channel bandwidth that are allocated for wireless energy transfer; and
transmit a signal for wireless energy transfer in the one or more frequency resources in accordance with the broadcast signal.

8. The apparatus of claim 7, wherein the instructions are further executable by the processor to cause the apparatus to:
power boost the signal for wireless energy transfer based at least in part on a power boosting threshold.

9. The apparatus of claim 7, wherein the instructions are further executable by the processor to cause the apparatus to:
determine that a subset of the one or more frequency resources is allocated for wireless energy transfer to an energy harvesting device of a plurality of energy harvesting devices, wherein the signal for wireless energy transfer is transmitted to the energy harvesting device in the subset of the one or more frequency resources.

10. The apparatus of claim 7, wherein the instructions are further executable by the processor to cause the apparatus to:
receive control signaling indicating a subcarrier spacing to use for the signal for wireless energy transfer, the control signaling comprising a master information block, a system information block, radio resource control signaling, a medium access control element, downlink control information, or a combination thereof, wherein the signal for wireless energy transfer is transmitted further based at least in part on the subcarrier spacing.

11. The apparatus of claim 7, wherein:
the channel bandwidth comprises a first bandwidth part preceding the one or more frequency resources in a frequency domain and a second bandwidth part following the one or more frequency resources in the frequency domain, the first bandwidth part and the second bandwidth part corresponding to a same subcarrier spacing; and
the signal for wireless energy transfer comprises an orthogonal frequency-division multiplexing waveform with the same subcarrier spacing as the first bandwidth part and the second bandwidth part.

12. The apparatus of claim 7, wherein:
the channel bandwidth comprises a first bandwidth part preceding the one or more frequency resources in a frequency domain and a second bandwidth part following the one or more frequency resources in the frequency domain, the first bandwidth part corresponding to a first subcarrier spacing and the second bandwidth part corresponding to a second subcarrier spacing; and
the signal for wireless energy transfer comprises an orthogonal frequency-division multiplexing waveform with the first subcarrier spacing, and the signal for wireless energy transfer is separated from the second bandwidth part in the frequency domain by a guard band; or
the signal for wireless energy transfer comprises the orthogonal frequency-division multiplexing waveform with the second subcarrier spacing, and the signal for wireless energy transfer is separated from the first bandwidth part in the frequency domain by the guard band.

13. The apparatus of claim 7, wherein:
the channel bandwidth comprises a first bandwidth part preceding the one or more frequency resources in a frequency domain and a second bandwidth part following the one or more frequency resources in the frequency domain, the first bandwidth part corresponding to a first subcarrier spacing and the second bandwidth part corresponding to a second subcarrier spacing; and
the signal for wireless energy transfer comprises an orthogonal frequency-division multiplexing waveform with a third subcarrier spacing different from the first subcarrier spacing and the second subcarrier spacing, and wherein the signal for wireless energy transfer is separated from the first bandwidth part in the frequency domain by a first guard band and is separated from the second bandwidth part in the frequency domain by a second guard band.

14. The apparatus of claim 7, wherein:
the channel bandwidth comprises a first bandwidth part preceding the one or more frequency resources in a frequency domain and a second bandwidth part following the one or more frequency resources in the frequency domain, the first bandwidth part corresponding to a first subcarrier spacing and the second bandwidth part corresponding to a second subcarrier spacing; and
the signal for wireless energy transfer comprises an orthogonal frequency-division multiplexing waveform with a plurality of subcarrier spacings comprising at least the first subcarrier spacing in a first portion adjacent to the first bandwidth part in the frequency domain and the second subcarrier spacing in a second portion adjacent to the second bandwidth part in the frequency domain.

15. The apparatus of claim 7, wherein the signal for wireless energy transfer is dedicated for energy transfer or comprises physical uplink control channel signaling, physical uplink shared channel signaling, sidelink signaling, signal shaping signaling, or a combination thereof.

16. An apparatus for wireless communications, comprising:
a processor;
memory coupled with the processor; and
instructions stored in the memory and executable by the processor to cause the apparatus to:
allocate, in a cellular network, one or more frequency resources within a channel bandwidth for wireless energy transfer; and
transmit a broadcast signal indicating the one or more frequency resources that are configured for wireless energy transfer.

17. The apparatus of claim 16, wherein the instructions are further executable by the processor to cause the apparatus to:
allocate one or more additional frequency resources within the channel bandwidth for wireless information transfer on an uplink channel, a downlink channel, or both.

18. The apparatus of claim 17, wherein the broadcast signal further indicates the one or more additional frequency resources that are allocated for wireless information transfer, the broadcast signal comprising a master information block, a system information block, or both.

19. The apparatus of claim 16, wherein the instructions are further executable by the processor to cause the apparatus to:
transmit, to an energy harvesting device, a signal for wireless energy transfer in the one or more frequency resources based at least in part on the allocated one or more frequency resources.

20. The apparatus of claim 19, wherein the instructions are further executable by the processor to cause the apparatus to:
power boost the signal for wireless energy transfer based at least in part on a power boosting threshold.

21. The apparatus of claim 20, wherein the instructions are further executable by the processor to cause the apparatus to:
select a first set of contiguous frequency resources of the one or more frequency resources for power boosting the signal for wireless energy transfer, wherein the signal for wireless energy transfer is power boosted in the first set of contiguous frequency resources based at least in part on the selecting; and
refrain from power boosting the signal for wireless energy transfer in a second set of contiguous frequency resources of the one or more frequency resources.

22. The apparatus of claim 19, wherein the signal for wireless energy transfer is dedicated for energy transfer or comprises physical downlink control channel signaling, physical downlink shared channel signaling, reference signaling, signal shaping signaling, or a combination thereof.

23. The apparatus of claim 16, wherein the instructions to allocate the one or more frequency resources for wireless energy transfer are further executable by the processor to cause the apparatus to:
allocate a first subset of the one or more frequency resources for wireless energy transfer to a first energy harvesting device of a plurality of energy harvesting devices; and
allocate a second subset of the one or more frequency resources for wireless energy transfer to a second energy harvesting device of the plurality of energy harvesting devices.

24. The apparatus of claim 16, wherein the broadcast signal comprises a master information block, a system information block, or both.

25. The apparatus of claim 16, wherein the instructions are further executable by the processor to cause the apparatus to:
configure the channel bandwidth with a first bandwidth part corresponding to a subcarrier spacing and preceding the one or more frequency resources in a frequency domain; and
configure the channel bandwidth with a second bandwidth part corresponding to the subcarrier spacing and following the one or more frequency resources in the frequency domain.

26. The apparatus of claim 16, wherein the instructions are further executable by the processor to cause the apparatus to:
apply, to first signaling transmitted in the one or more frequency resources that are configured for wireless energy transfer, an emission threshold associated with the first signaling affecting frequency resources outside the one or more frequency resources; and
refrain from applying, to second signaling transmitted in the frequency resources outside the one or more frequency resources that are configured for wireless energy transfer, the emission threshold associated with the second signaling affecting the one or more frequency resources.

27. The apparatus of claim 16, wherein the instructions are further executable by the processor to cause the apparatus to:
apply a total emission threshold associated with both first signaling for wireless energy transfer and second signaling for wireless information transfer affecting frequency resources outside the channel bandwidth.

28. A method for wireless communications, comprising:
receiving, in a cellular network, a broadcast signal indicating one or more frequency resources within a channel bandwidth that are allocated for wireless energy transfer;
receiving a signal within the one or more frequency resources, the signal being available for wireless energy transfer in accordance with the broadcast signal; and
performing energy harvesting using the signal received within the one or more frequency resources allocated for wireless energy transfer.

29. The method of claim 28, further comprising:
performing additional energy harvesting using one or more additional signals received outside of the one or more frequency resources, the one or more additional signals being for wireless information transfer.

30. The method of claim 28, wherein receiving the broadcast signal comprises:
receiving a master information block, a system information block, or both, wherein the master information block, the system information block, or a combination thereof indicates the one or more frequency resources.
